(19) United States
(12) Patent Application Publication
(10) Pub. No.: US 2025/0189077 A1
(43) Pub. Date: Jun. 12, 2025

(54) AUTOMATED GAS SUPPLY SYSTEM INCLUDING MOBILE ROBOT DEVICE

(71) Applicant: KC CO., LTD., Gyeonggi-do (KR)

(72) Inventors: Yong Geon PARK, Gyeonggi-do (KR); Sang Jin KIM, Gyeonggi-do (KR); Jung Hoon LEE, Gyeonggi-do (KR); Sang Wook LEE, Gyeonggi-do (KR); Jong Chan KIM, Gyeonggi-do (KR); Du Seok LEE, Gyeonggi-do (KR)

(73) Assignee: KC CO., LTD., Gyeonggi-do (KR)

(21) Appl. No.: 18/969,270

(22) Filed: Dec. 5, 2024

(30) Foreign Application Priority Data
Dec. 8, 2023 (KR) 10-2023-0177887
Sep. 6, 2024 (KR) 10-2024-0121719

(51) Int. Cl. F17C 5/00; B25J 5/00; B25J 9/16; B25J 9/20; B25J 15/00

(52) U.S. Cl. CPC F17C 5/007; B25J 5/007; B25J 9/1682; B25J 9/20; B25J 15/0019

(57) ABSTRACT

A gas supply system includes a cabinet, a fastening device fastenable a valve of a gas container while aligned with the gas container, a mobile robot device detachably connected to the fastening device and configured to move and operate the fastening device. The mobile robot device includes a body, a first collaborative robot disposed on the body, a second collaborative robot disposed on the body, a three-dimensional (3D) vision camera configured to collect an image, and a controller configured to control an operation of the first collaborative robot and an operation of the second collaborative robot based on the collected image.

### CROSS-REFERENCE TO RELATED APPLICATION

This application claims the benefit of Korean Patent Application No. 10-2023-0177887 filed on Dec. 8, 2023, and Korean Patent Application No. 10-2024-0121719 filed on Sep. 6, 2024, in the Korean Intellectual Property Office, the entire disclosures of which are incorporated herein by reference for all purposes.

### BACKGROUND

### 1. Field of the Invention

The following embodiments relate to an automated gas supply system including a mobile robot device.

### 2. Description of the Related Art

In general, for a process that uses gas, for example, a process in which precise tasks are performed, such as a semiconductor manufacturing process, it is required to supply an appropriate type of gas for each process while satisfying a predetermined concentration and pressure.

For efficient gas supply during the process, various types of gases are stored in gas containers under high pressure, and gas containers holding gases with substances harmful to the human body are stored unmanned under strict management.

A gas container is connected to a gas supply device to discharge the gas stored therein, and when the gas in the gas container is completely exhausted, a series of replacement operations of disconnecting the gas supply device from a valve of the gas container, removing the gas container, and connecting a new gas container to the gas supply device are performed.

Meanwhile, to connect the gas supply device to the gas container, the valve of the gas container and the gas supply device need to be aligned. However, since it is difficult to align the gas container in the desired position due to its great weight, the gas supply device is aligned with respect to the valve of the gas container. The gas supply device includes an actuator for adjusting its position and receiving power for operation, and thus, it is required to form a cabinet, where the gas supply is performed, in a size to accommodate the gas supply device.

The above description is information the inventor(s) acquired during the course of conceiving the present disclosure, or already possessed at the time, and is not necessarily art publicly known before the present application was filed.

### SUMMARY

An embodiment is intended to provide an automated gas supply device miniaturized by positioning a power source outside.

An embodiment is intended to provide an automated gas supply device that may be aligned with respect to a gas container through three-dimensional (3D) mapping through a mobile robot device.

According to an aspect, there is provided a gas supply system including a cabinet in which a gas container is disposed, a connector fastenable to a valve of the gas container, the connector configured to supply a process gas in the gas container to a supply pipe while fastened to the valve, and a mobile robot device disposed outside the cabinet and configured to automatically fasten the connector to the valve. The mobile robot device may include a body movable outside the cabinet, a first collaborative robot including a first multi-joint arm disposed on the body and having a multi-degree-of-freedom motion, the first collaborative robot configured to operate to fasten the connector to the valve, a second collaborative robot including a second multi-joint arm disposed on the body and having a multi-degree-of-freedom motion, the second collaborative robot configured to operate to support the gas container, a three-dimensional (3D) vision camera configured to collect an image, and a controller configured to control an operation of the first collaborative robot and an operation of the second collaborative robot based on the image collected by the 3D vision camera.

The first collaborative robot may further include a first grip module installed at an end portion of the first multi-joint arm and configured to grip the connector, and the first collaborative robot may be configured to fasten the connector to the valve in a state in which the first grip module grips the connector.

The controller may be configured to determine operation information of the first collaborative robot according to a set algorithm, and the set algorithm may be configured to generate in real time a 3D model for the valve and the connector through the collected image, determine an image similarity by comparing the generated 3D model with a set reference model, and operate the first collaborative robot to place the connector in a predicted position of the connector in which the image similarity is greater than or equal to a set value.

The controller may be configured to determine a valve fastening position in which the connector is aligned to be fastenable to the valve based on the image collected by the 3D vision camera, and control the operation of the first collaborative robot so that the connector is placed in the valve fastening position.

The second collaborative robot may further include a second grip module installed at an end portion of the second multi-joint arm and configured to grip an object.

The second collaborative robot may be configured so that the second grip module grips and supports the gas container, during a process in which the first collaborative robot operates to fasten the connector to the valve.

The controller may be configured to determine a gripping position for the second grip module to grip the gas container, based on the image collected by the 3D vision camera, and operate the second collaborative robot to move to the gripping position and then grip the gas container.

The second collaborative robot may be configured to grip a gasket through the second grip module. The controller may be configured to operate the second grip module to detach and attach the gasket from and to the connector or the valve based on the image collected by the 3D vision camera.

The cabinet may include a support chain to surround the gas container, and the first collaborative robot or the second collaborative robot may be configured to adjust a position of the support chain in the cabinet.

One or more 3D vision cameras may be provided, and disposed in at least one of the first multi-joint arm or the second multi-joint arm.

According to an aspect, there is provided a gas supply system including a cabinet in which a gas container is disposed, a fastening device configured to fasten a connector to a valve of the gas container while aligned with the valve, and a mobile robot device configured to automatically align the fastening device to the gas container. The mobile robot device may include a body movable along a ground, a first collaborative robot disposed on the body, and including a first multi-joint arm, a second collaborative robot disposed on the body, and including a second multi-joint arm, and a 3D vision camera configured to collect an image, and a controller configured to control an operation of the first collaborative robot and an operation of the second collaborative robot based on the image collected by the 3D vision camera. The first collaborative robot may be detachably connected to the fastening device and configured to move the fastening device.

The first collaborative robot may further include a docking module installed at an end portion of the first multi-joint arm and docked on the fastening device while aligned with the fastening device, and the docking module may be configured to supply power to the fastening device while docked on the fastening device.

The controller may be configured to determine a docking position in which the docking module is aligned to be fastenable to the fastening device based on the image collected by the 3D vision camera, and control the operation of the first collaborative robot so that the docking module is placed in the docking position.

The docking module may include a docking plate on which one or more docking members are formed, and a power motor configured to supply power to the fastening device while docked on the fastening device, and the fastening device may include one or more support clamps detachably coupled to the docking member, and a power transmitter to which the power motor is connected, the power transmitter configured to receive power from the power motor.

The docking position may be determined according to a set algorithm, and the set algorithm may be configured to generate in real time a 3D model for a virtual space through the 3D vision camera, determine an image similarity by comparing the generated 3D model with a set reference model, and determine a predicted position of the docking module in which the image similarity is greater than or equal to a set value to be the docking position.

The fastening device may further include an end cap detacher configured to remove an end cap from the valve of the gas container. The end cap detacher may be rotatable about a first rotation axis, the end cap detacher may include an insertion recess formed in a shape corresponding to the end cap so that the end cap is insertable along the first rotation axis, and the first rotation axis may coincide with a central axis of the valve in a state in which the fastening device is aligned in a first position.

The connector may be configured to rotate about a second rotation axis or translate along the second rotation axis, and the second rotation axis may coincide with a central axis of the valve in a state in which the fastening device is aligned in a second position.

According to an aspect, there is provided a gas supply system including a cabinet in which a gas container is disposed, a fastening device movably installed in the cabinet and fastened to a valve of the gas container through a connector while aligned with the valve, and a mobile robot device disposed outside the cabinet and configured to automatically align the fastening device with the gas container. The fastening device may include a docking portion configured to receive power from an outside. The mobile robot device may include a body movable along a ground, a first collaborative robot disposed on the body, and including a first multi-joint arm, a second collaborative robot disposed on the body, and including a second multi-joint arm, a 3D vision camera configured to collect an image, and a controller configured to control an operation of the first collaborative robot and an operation of the second collaborative robot based on the image collected by the 3D vision camera. The first collaborative robot may include a docking module installed at an end portion of the first multi-joint arm, connected to the fastening device while aligned with the fastening device, and configured to operate the fastening device. The second collaborative robot may include a gasket gripper installed at an end portion of the second multi-joint arm and configured to grip a gasket.

The mobile robot device may further include a gasket storage disposed in the body and configured to store the gasket.

The controller may be configured to determine a gasket replacement position to replace the gasket based on the image collected by the 3D vision camera, and control the operation of the second collaborative robot to move the gasket gripper to the determined gasket replacement position.

Additional aspects of embodiments will be set forth in part in the description which follows and, in part, will be apparent from the description, or may be learned by practice of the disclosure.

The effects of the gas supply system according to embodiments are not limited to the above-mentioned effects, and other unmentioned effects may be clearly understood from the following description by one of ordinary skill in the art.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a perspective view of a portion of a gas container according to an embodiment;

FIG. 2A is a perspective view of a gas supply system according to an embodiment;

FIG. 2B is a front view of a gas supply system according to an embodiment;

FIG. 2C is a perspective view illustrating a fastening device and a position adjustment module according to an embodiment;

FIG. 2D is a view schematically illustrating a process of adjusting the position of a fastening device according to an embodiment;

FIG. 2E is a perspective view of a mobile robot device according to an embodiment;

FIG. 2F is a view illustrating a docking module according to an embodiment;

FIG. 2G is a view illustrating a process of connecting a docking module to a fastening device according to an embodiment;

FIG. 3A is a perspective view of a gas supply system according to an embodiment;

FIG. 3B is a perspective view of a mobile robot device according to an embodiment;

FIG. 3C is a view illustrating a docking module according to an embodiment;

FIG. 3D is an operational view illustrating a process of aligning a first collaborative robot and a second collaborative robot using a three-dimensional (3D) vision camera in a gas supply system according to an embodiment;

FIG. 3E is a view illustrating a process of fastening a mobile robot device to a fastening device according to an embodiment;

FIG. 4A is a perspective view of a gas supply system according to an embodiment;

FIG. 4B is a view illustrating a state in which gas containers are disposed in a cabinet in a gas supply system according to an embodiment;

FIG. 4C is a perspective view of a mobile robot device according to an embodiment;

FIG. 4D is an operational view illustrating an operation of fastening a support chain by a mobile robot device according to an embodiment;

FIG. 4E is an operational view illustrating a process of aligning a connector with a valve of a gas container using a 3D vision camera by a mobile robot device according to an embodiment;

FIG. 5 is a perspective view of a mobile robot device according to an embodiment; and

FIG. 6 is a flowchart of a gas supply method according to an embodiment.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled” or “joined” to another component, the former may be directly “connected,” “coupled,” and “joined” to the latter or “connected”, “coupled”, and “joined” to the latter via another component.

The same name may be used to describe an element included in the embodiments described above and an element having a common function. Unless otherwise mentioned, the descriptions of the examples may be applicable to the following examples and thus, duplicated descriptions will be omitted for conciseness.

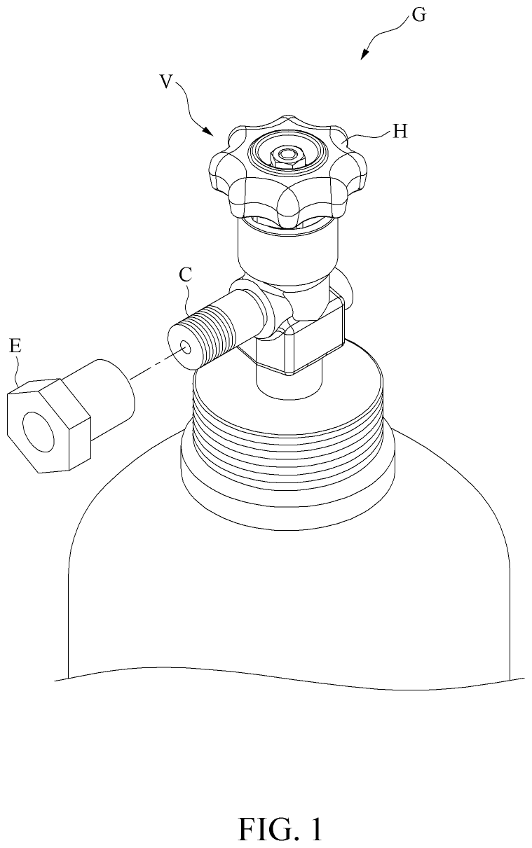

FIG. 1 is a perspective view of a portion of a gas container according to an embodiment.

Referring to FIG. 1, a gas container G may store a process gas therein. A valve assembly V may be mounted on the upper portion of the gas container G. The valve assembly V may be used to discharge the gas stored in the gas container G to the outside or to inject a gas into the gas container G. The valve assembly V may optionally regulate the gas flow through the valve assembly V, while providing a gas flow path between the inside of the gas container G and the outside. In an embodiment, the valve assembly V may include a valve C with an open outlet so that a gas flows through. The valve C may be formed, for example, to protrude from a side surface of the valve assembly V. In an embodiment, the valve C may be fastened to a connector of a fastening device described later, so as to supply the gas stored in the gas container G to the outside. In an embodiment, the valve assembly V may include a valve shutter (not shown) to regulate the gas flow through the valve C, and the valve shutter may regulate the gas flow through the valve C through the rotational motion of a valve handle H disposed in the upper portion of the valve assembly V.

In an embodiment, an end cap E may be mounted on the outer circumferential surface of the valve C of the gas container G to prevent gas leakage by covering the outlet. The end cap E may be mounted on the valve C to enclose the outer circumferential surface of the valve C. In an embodiment, the end cap E may be screwed onto the valve C along the outer circumferential surface of the valve C to be mounted on the valve C or removed from the valve C. To discharge the process gas from the inside of the gas container G, the end cap E mounted on the valve C needs to be removed first. When a series of operations of receiving the gas from the gas container G is completed, the end cap E may be mounted again on the valve C of the gas container G to close the outlet.

The structure of the gas container G described with reference to FIG. 1 is an example, and gas containers G of various shapes and structures may be used in a gas supply system 1 described below. Hereinafter, for ease of description, a gas supply system will be described based on the gas container G shown in FIG. 1.

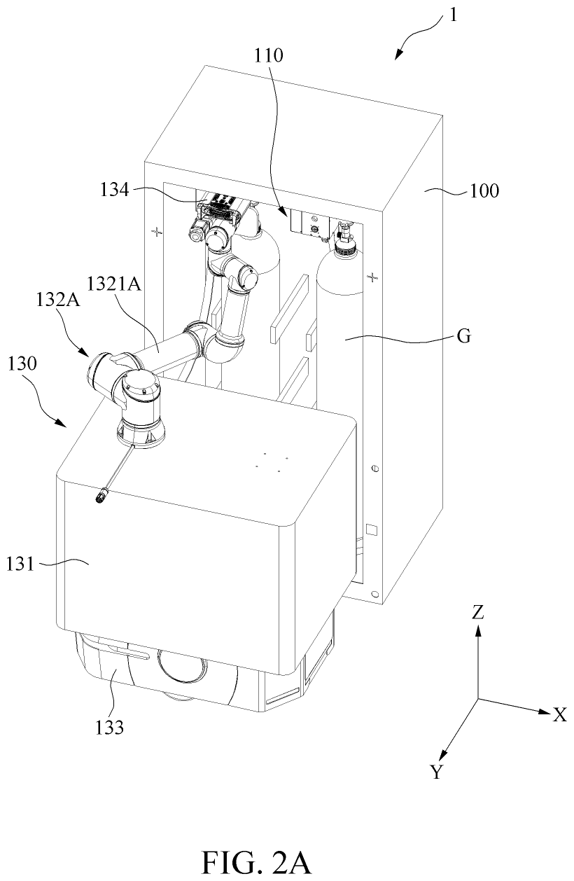

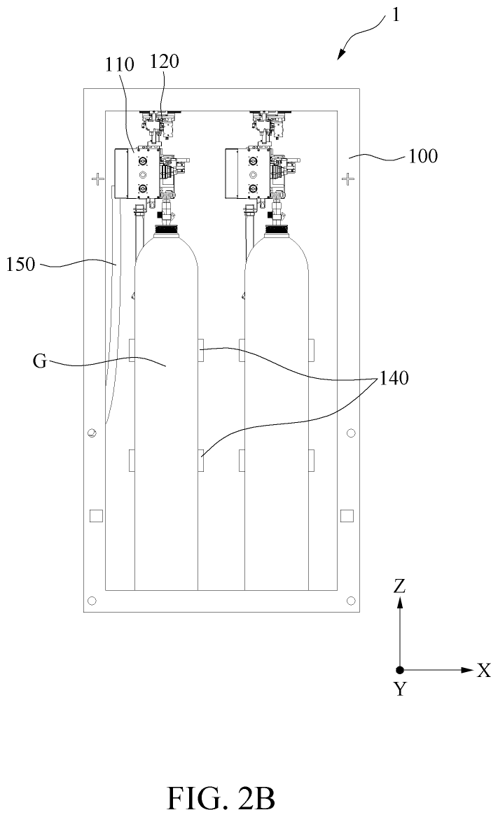

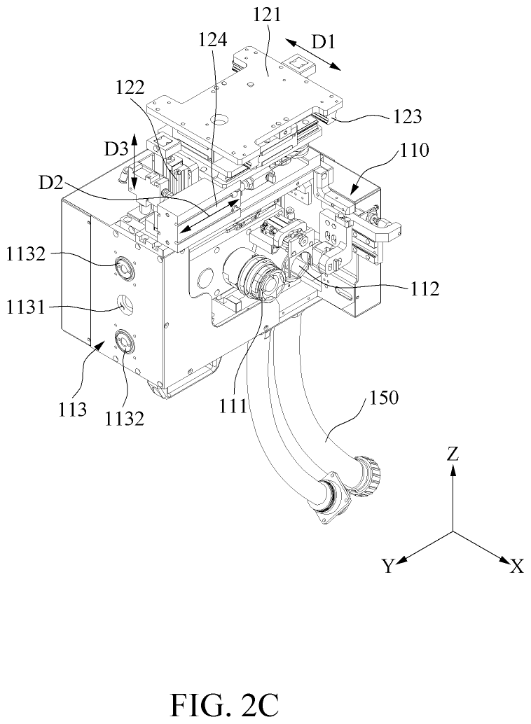

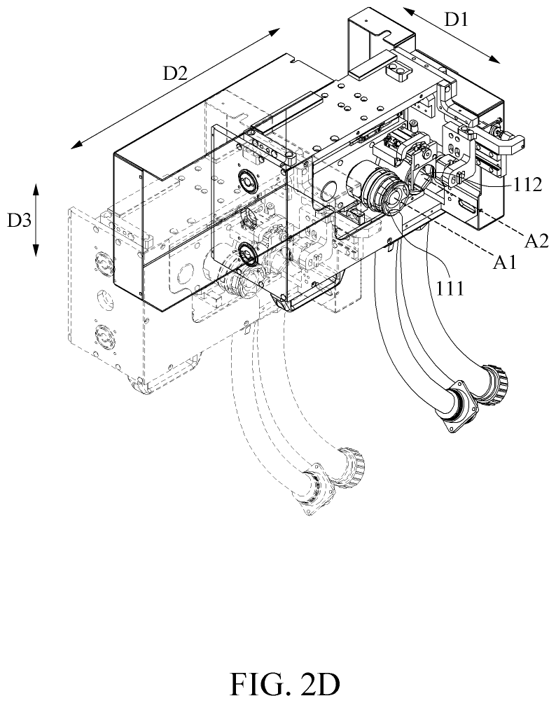

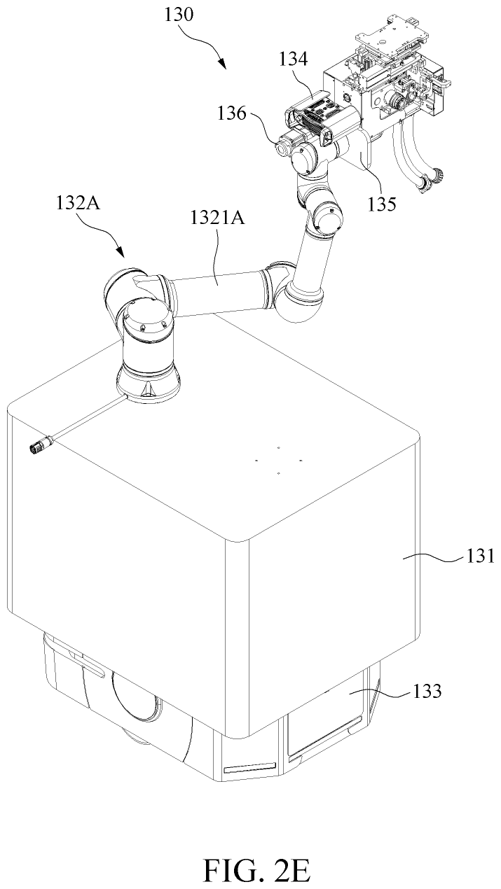

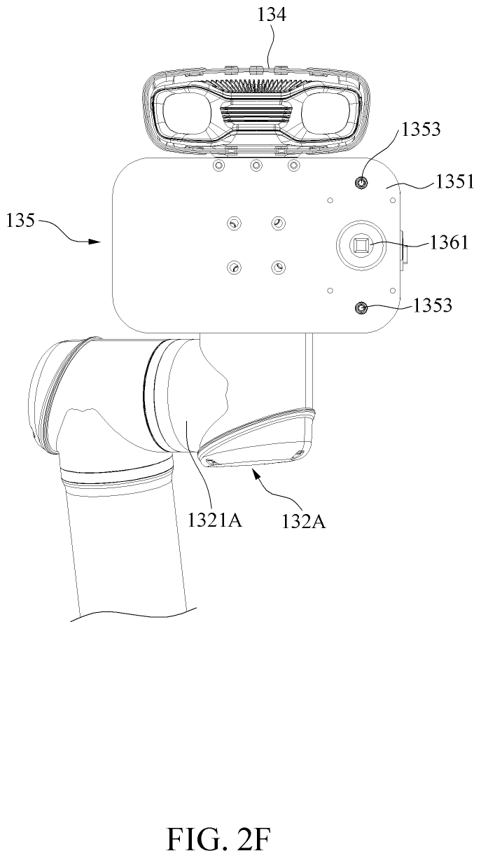

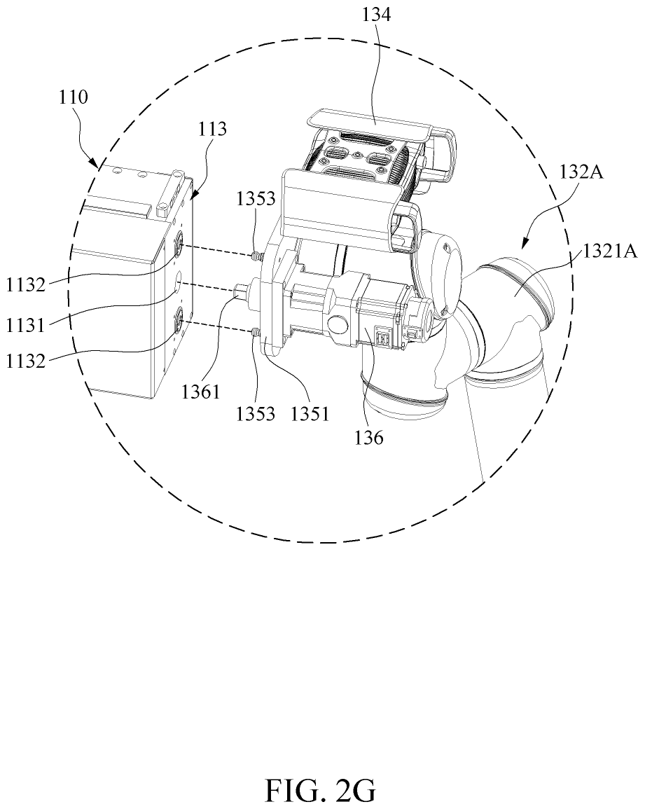

FIG. 2A is a perspective view of a gas supply system according to an embodiment. FIG. 2B is a front view of the gas supply system according to an embodiment. FIG. 2C is a perspective view illustrating a fastening device and a position adjustment module according to an embodiment. FIG. 2D is a view schematically illustrating a process of adjusting the position of the fastening device according to an embodiment. FIG. 2E is a perspective view of a mobile robot device according to an embodiment. FIG. 2F is a view illustrating a docking module according to an embodiment. FIG. 2G is a view illustrating a process of connecting the docking module to the fastening device according to an embodiment.

Referring to FIGS. 2A to 2G, a gas supply system 1 according to an embodiment may be automatically fastened to a gas container G disposed at a safe placing position in a cabinet 100. In an embodiment, the gas supply system 1 may automatically detach or attach an end cap E mounted on a valve C of the gas container G. The gas supply system 1 may be fastened to the valve C of the gas container G to supply a gas inside the gas container G to a gas pipe 150.

In an embodiment, the gas supply system 1 may include a cabinet 100, a fastening device 110, a position adjustment module 120, and a mobile robot device 130 disposed outside the cabinet 100.

In an embodiment, the cabinet 100 may accommodate the gas container G therein. The cabinet 100 may form an internal space where the gas container G is disposed. The cabinet 100 may include a door portion (not shown) to open and close the internal space so that the gas container G may enter the internal space or the gas container G may leave the internal space after use. In the drawings, it is shown that the internal space of the cabinet 100 is open (e.g., in the +Y direction of the cabinet 100 of FIG. 2), but this is for ease of description. The internal space of the cabinet 100 may be opened and closed by the door portion that is not shown. The door portion may seal the internal space of the cabinet 100 to reduce or prevent the gas stored in the gas container G from leaking out of the cabinet 100, during the process of supplying a gas from the gas container G disposed inside the cabinet 100 to the gas pipe 150.

In an embodiment, one or more gas containers G may be disposed in the cabinet 100. For example, as shown in FIG. 2, two gas containers G and two fastening devices 110 respectively fastened to the two gas containers G may be disposed in the cabinet 100. However, this is an example, and the number of gas containers G and the number of fastening devices 110 corresponding thereto are not limited and may be changed depending on the design. Hereinafter, the configuration of the gas supply system 1 will be described based on one gas container G and one fastening device 110 corresponding thereto disposed in the cabinet 100.

In an embodiment, a support clamp 140 may be disposed in the cabinet 100 to support the outer circumferential surface of the gas container G that is safely placed. The support clamp 140 may operate to optionally grip the outer circumferential surface of the gas container G or move away from the outer circumferential surface of the gas container G.

In an embodiment, the position adjustment module 120 may movably connect the fastening device 110 to the cabinet 100. In an embodiment, the position adjustment module 120 may include a fixed plate 121, a first moving member 123, a second moving member 124, and a third moving member 122.

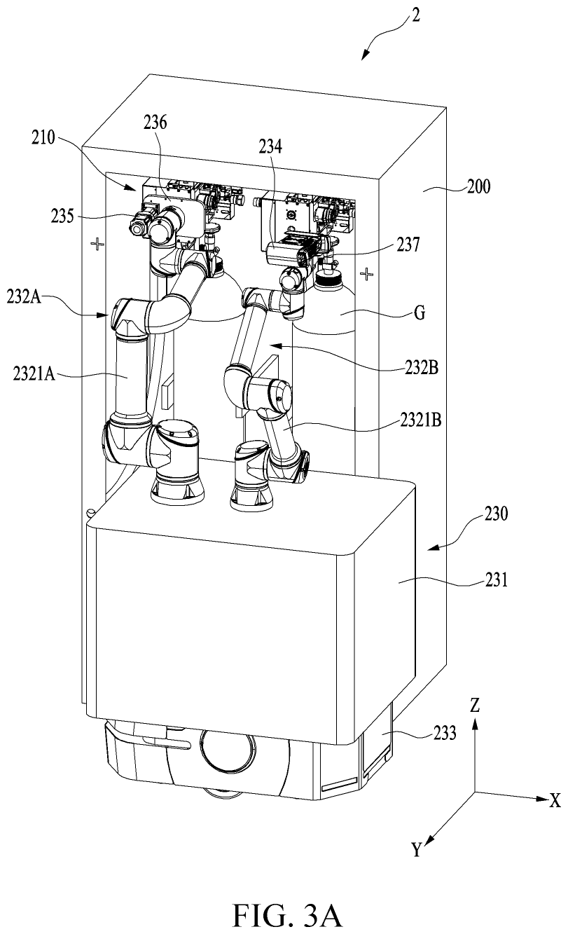

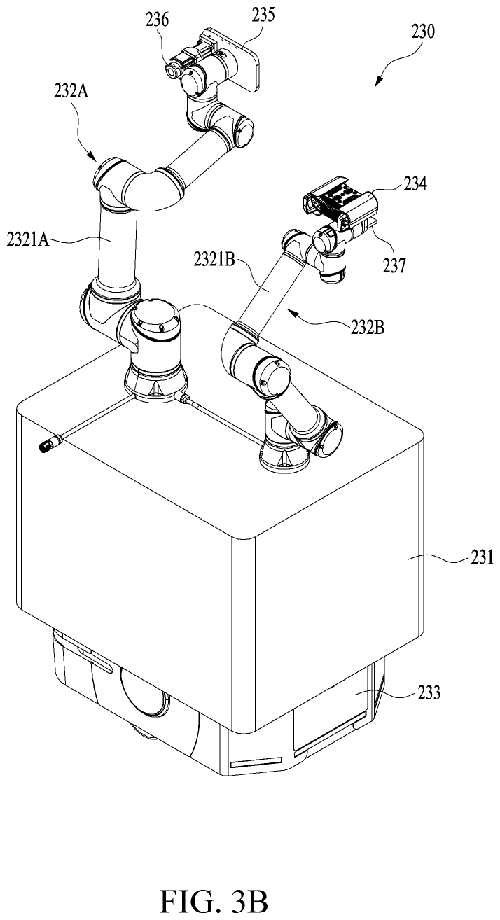

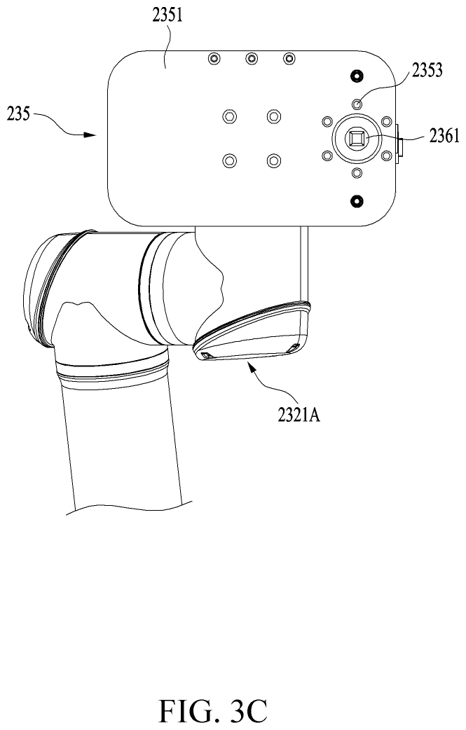

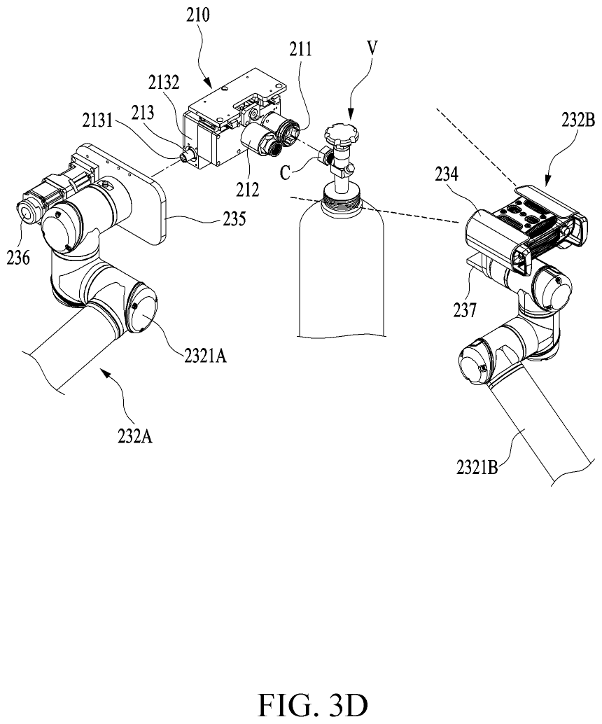

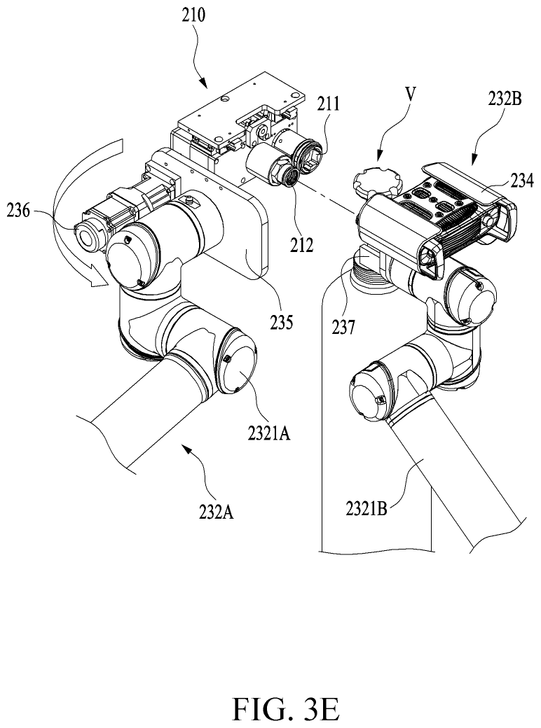

In an embodiment, the fixed plate 121 may be fixed to the internal space of the cabinet 100. For example, the fixed plate 121 may be fixed to the top surface of the internal space. The first moving member 123 may connect the fixed plate 121 and the fastening device 110, and move with respect to the fixed plate 121 in a first direction D1 parallel to the ground. The second moving member 124 may connect the fixed plate 121 and the fastening device 110, and move with respect to the fixed plate 121 in a second direction D2 parallel to the ground and perpendicular to the first direction D1. The third moving member 122 may connect the fixed plate 121 and the fastening device 110, and move with respect to the fixed plate 121 in a third direction D3 perpendicular to the ground, for example, the third direction perpendicular to the first direction D1 and the second direction D2. In an embodiment, the first moving member 123, the second moving member 124, and the third moving member 122 may be sequentially connected from the fixed plate 121 along the fastening device 110, and the relative connection order of the moving members is not limited thereto. For example, as shown in FIG. 3B, the first moving member 123 may be connected to the fixed plate 121 to move in the first direction D1, the third moving member 122 may be connected to the first moving member 123 to move in the third direction D3, and the second moving member 124 may be connected to the third moving member 122 to move in the second direction D2. However, the connection order thereof is not limited thereto.

In an embodiment, the position adjustment module 120 may adjust the three-dimensional (3D) coordinates of the fastening device 110 with respect to the fixed plate 121 through the movement of each moving member 123, 124, or 122. Accordingly, when a mobile robot device 130 described below applies an external force to move the fastening device 110 in a state in which the mobile robot device 130 is connected to the fastening device 110, the position adjustment module 120 may operate in response to the external force applied to the fastening device 110 and adjust the relative position of the fastening device 110 with respect to the fixed plate 121, thereby changing the position of the fastening device 110 in the internal space of the cabinet 100. Through this operation, the fastening device 110 may be aligned with respect to the valve C of the gas container G.

In an embodiment, the position adjustment module 120 may rotate the fastening device 110 in the internal space of the cabinet 100. For example, the position adjustment module 120 may include a structure for implementing a three-degree-of-freedom rotational motion of the fastening device 110. For example, the position adjustment module 120 may include a plurality of rotating members (not shown) that connect the fixed plate 121 and the fastening device 110 and enable the fastening device 110 to move in three degrees of freedom of yaw, pitch, and roll with respect to the fixed plate 121. According to this structure, the fastening device 110 may perform translational motions in three degrees of freedom and rotational motions in three degrees of freedom with respect to the fixed plate 121 by means of the position adjustment module 120, so that the 3D position and change thereof may be changed in the cabinet 100.

In an embodiment, the fastening device 110 may be installed movably in the internal space of the cabinet 100. As mentioned above, the fastening device 110 may be connected to the inside of the cabinet 100 through the position adjustment module 120, and the position and angle thereof in the cabinet 100 may be adjusted through the operation of the position adjustment module 120.

In an embodiment, the fastening device 110 may operate to detach an end cap (e.g., the end cap E of FIG. 1) from the valve C of the gas container G or to be fastened to the valve C of the gas container G to receive a gas. The fastening device 110 may be configured to detach/mount the end cap E in a state of being relatively aligned with respect to the valve C of the gas container G or to be fastened to the valve C.

In an embodiment, the fastening device 110 may include an end cap detacher 111 for removing or mounting the end cap from or on the valve C of the gas container G, a connector 112 detachably fastened to the valve C of the gas container G, and a docking portion 113 connected to the mobile robot device 130 to receive power.

In an embodiment, the end cap detacher 111 may detach and remove the end cap E mounted on the valve C, or mount the end cap again on the valve C of the gas container G after use. In an embodiment, an insertion recess into which at least a portion of the end cap is inserted may be formed in the end cap detacher 111. The insertion recess may be formed in a shape corresponding to the cross section of the end cap. For example, when the end cap is formed to have a regular hexagonal cross section as shown in FIG. 1, the insertion recess formed in the end cap detacher 111 may be formed to have a regular hexagonal cross section corresponding to the cross section of the end cap so that the end cap may be inserted thereinto. In an embodiment, the end cap detacher 111 may rotate about a first rotation axis A1. The first rotation axis A1 may be disposed to penetrate through the center of the insertion recess. In an embodiment, in a state in which the fastening device 110 is aligned with respect to the valve C at a first position, the first rotation axis A1 of the end cap detacher 111 may coincide with the central axis of the end cap.

In an embodiment, since the end cap is detached from and fastened to the valve C in a screwing manner, the end cap detacher 111 may unscrew the end cap from the valve C or screw the end cap onto the valve C by rotating about the first rotation axis while gripping the outer surface of the end cap through the insertion recess.

In an embodiment, in a state in which the fastening device 110 is aligned in a first position with respect to the valve C of the gas container G, the end cap detacher 111 may be placed in a state to detach the end cap from the valve C or mount the end cap thereon. For example, in a state in which the fastening device 110 is aligned in the first position with respect to the valve C of the gas container G, the end cap detacher 111 may be disposed to face the valve C in a state in which the first rotation axis A1 coincides with the central axis of the valve C, that is, the rotation center of the end cap mounted on the valve C.

In an embodiment, for the end cap to be inserted into the insertion recess of the end cap detacher 111, the rotation angle of the end cap needs to be adjusted to match the shape of the insertion recess with the shape of the end cap in a state in which the first rotation axis A1 coincides with the central axis of the valve C. In an embodiment, the end cap detacher 111 may rotate about the first rotation axis A1 through the power received from the mobile robot device 130 described below, thereby adjusting the relative rotation angle with respect to the end cap. For example, the first rotation axis A1 of the end cap detacher 111 and the central axis of the end cap may coincide through the position adjustment of the fastening device 110, and the rotation angle of the end cap detacher 111 may be performed by a rotational motion of the end cap detacher 111 on the first rotation axis A1.

In an embodiment, when the axial coincidence and rotation angle adjustment of the end cap detacher 111 with respect to the end cap is completed, the end cap detacher 111 may advance toward the end cap along the first rotation axis A1 and accommodate the end cap in the insertion recess. With the end cap inserted into the insertion recess, the end cap detacher 111 may translate along the first rotation axis A1 while rotating about the first rotation axis A1, thereby removing the end cap from the valve C. The end cap may be mounted again on the valve C by performing the end cap detaching operation reversely.

In an embodiment, a connector 112 may be connected to the gas pipe 150 and connected to the valve C of the gas container G with the end cap removed, to receive a gas from the gas container G. In an embodiment, the connector 112 may operate to be fastened to the valve C, in a state in which the fastening device 110 is aligned in a second position with respect to the valve C of the gas container G. In the state in which the fastening device 110 is aligned in the second position with respect to the valve C of the gas container G, the connector 112 may be disposed to face the valve C. The connector 112 may be fastened to the valve C in such as manner of being screwed onto the valve C through threads formed on the outer circumferential surface of the valve C.

In an embodiment, the connector 112 may rotate along a second rotation axis A2. In an embodiment, the connector 112 may translate forward and backward along the second rotation axis A2. In an embodiment, the second rotation axis A2 of the connector 112 may substantially coincide with the central axis of the valve C in a state in which the fastening device 110 is aligned in the second position with respect to the valve C of the gas container G. In this case, the connector 112 may be fastened to the valve C by advancing toward the valve C along the second rotation axis A2. In an embodiment, the rotational and advancing motion of the connector 112 may be performed by the power received from the mobile robot device 130.

In an embodiment, the second rotation axis A2 of the connector 112 and the first rotation axis A1 of the end cap detacher 111 may be disposed in parallel substantially on the same plane. According to this structure, when the fastening device 110 translates in one direction (e.g., the second direction D2 of FIG. 3C) in a state in which the fastening device 110 is aligned in the first position with respect to the valve C of the gas container G, for example, in a state in which the first rotation axis A1 of the end cap detacher 111 coincides with the central axis of the end cap, the fastening device 110 may be aligned in the second position with respect to the valve C of the gas container G. In this case, the connector 112 and the end cap detacher 111 may be disposed side by side.

In another example not shown in the drawings, the connector 112 and the end cap detacher 111 may be formed so that the second rotation axis A2 and the first rotation axis A1 coincide. For example, the connector 112 may be positioned inside the insertion recess of the end cap detacher 111 and formed to rotate about the same rotation axis as the end cap detacher 111. In this case, as the fastening device 110 translates along the first rotation axis A1 in a state in which the fastening device 110 is aligned in the first position with respect to the valve C of the gas container G, for example, in a state in which the first rotation axis A1 of the end cap detacher 111 coincides with the central axis of the end cap, the fastening device 110 may be aligned in the second position with respect to the valve C of the gas container G.

Meanwhile, the position and angle of the fastening device 110 in the first position of being aligned to detach/mount the end cap from/on the valve C and the position and angle of the fastening device 110 in the second position of being aligned to be fastened to the valve C may vary relatively according to the position and angle of the valve C of the gas container C disposed in the cabinet 100.

In an embodiment, the docking portion 113 may be disposed to be exposed on the outer surface of the fastening device 110. For example, the docking portion 113 may be positioned on a side of the fastening device 110 facing the open portion of the cabinet 100 (e.g., a side of the fastening device 110 facing the +Y axis of FIG. 3A). In an embodiment, the mobile robot device 130 may be detachably connected to the docking portion 113. For example, a docking module 135 of the mobile robot device 130 described later may be fastened to the docking portion 113.

In an embodiment, in a state in which the mobile robot device 130 is connected to the docking portion 113, the position of the fastening device 110 in the internal space of the cabinet 100 may be changed by the mobile robot device 130. In an embodiment, in a state in which the mobile robot device 130 is connected to the docking portion 113, the fastening device 110 may receive power supplied by the mobile robot device 130 through the docking portion 113 and operate the end cap detacher 111 and the connector 112.

In an embodiment, the docking portion 113 may include a docking clamp 1132 to which the docking module 135 of the mobile robot device 130 is fastened, and a power transmitter 1131 to which a rotation shaft 1361 of a power motor of the mobile robot device 130 is connected. In an embodiment, the docking clamp 1132 may hold the fastening state of the docking module 135 to the docking portion 113 or release the fastening state so that the docking module 135 is detached therefrom. The docking portion 113 will be described further below.

In an embodiment, the mobile robot device 130 may move outside the cabinet 100. The mobile robot device 130 may be detachably connected to the fastening device 110, and may move the fastening device 110 or supply power to the fastening device 110 in a state of being connected to the fastening device 110. In an embodiment, the mobile robot device 130 may include a body 131, a traveling portion 133, a first collaborative robot 132A, a 3D vision camera 134, and a controller.

In an embodiment, the body 131 may form the body of the mobile robot device 130. The components (e.g., an actuator, a controller, a communication device, etc.) for the operation of the mobile robot device 130 may be disposed inside the body 131. The body 131 may move along the ground.

In an embodiment, the traveling portion 133 may be disposed at the lower end of the body 131. The traveling portion 133 may move the body 131 along the ground. The traveling portion 133 may include, for example, a guide member that moves along a guide rail installed on the ground, or may include a rolling member that moves on the ground. In an embodiment, the traveling portion 133 may operate to move the mobile robot device 130 according to an instruction from the controller.

In an embodiment, the first collaborative robot 132A may be installed on the body 131. In an embodiment, the first collaborative robot 132A may be disposed on the upper portion of the body 131. In an embodiment, the first collaborative robot 132A may include a first multi-joint arm 1321A that implements movement in multiple degrees of freedom, for example, movement in six degrees of freedom. For example, the first collaborative robot 132A may implement 3D movement with respect to the ground (e.g., translational movement in the X-, Y-, and Z-axial directions) and an angular movement in three directions (e.g., movement of roll, yaw, and pitch) through the operation of the first multi-joint arm 1321A.

In an embodiment, the first collaborative robot 132A may include a docking module 135 disposed at an end portion of the first multi-joint arm 1321A. In an embodiment, the docking module 135 may be detachably fastened to the docking portion 113 of the fastening device 110 through the operation of the first multi-joint arm 1321A. The docking module 135 may be fastened to the docking portion 113 to move the fastening device 110 according to the operation of the first multi-joint arm 1321A, and may provide power to the fastening device 110 in a state of being fastened to the fastening device 110.

In an embodiment, the docking module 135 may include a docking plate 1351, a docking member 1353, and a power motor 136.

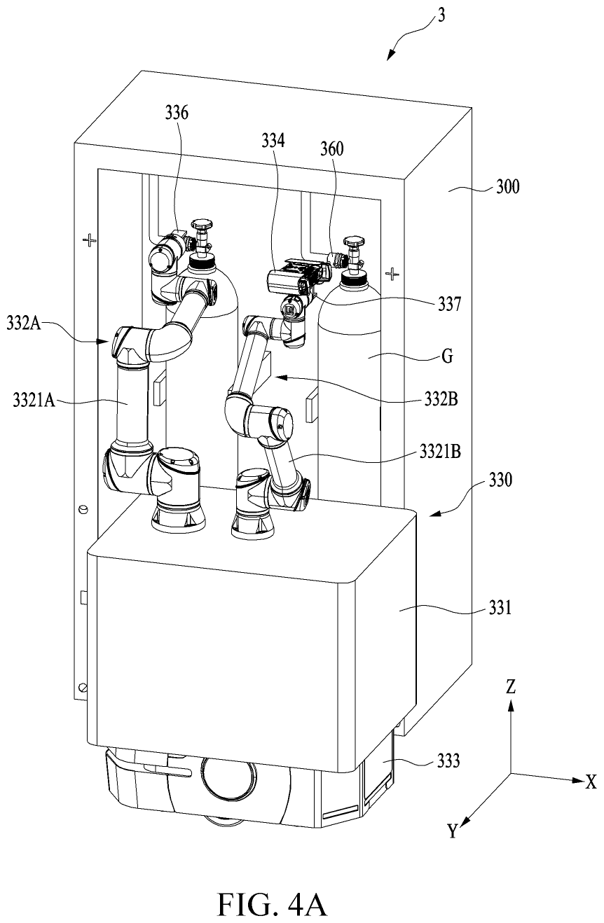

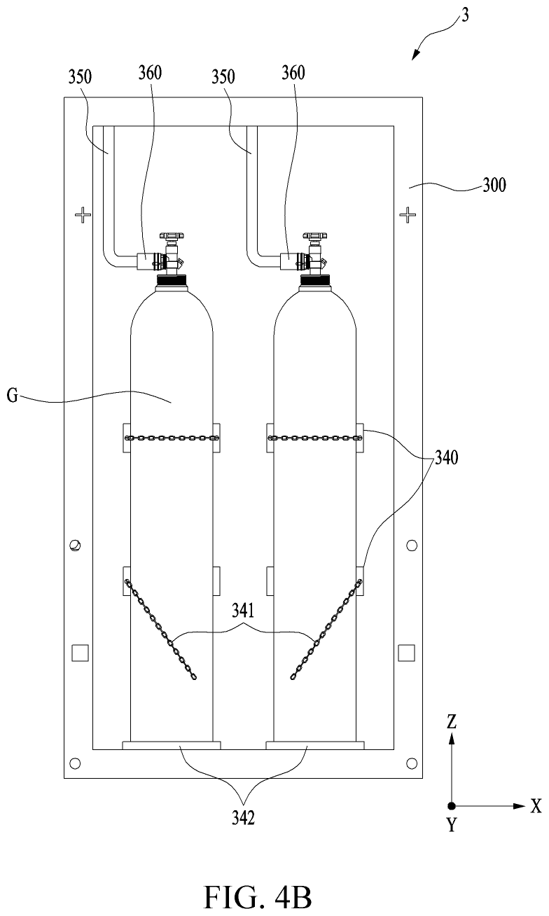

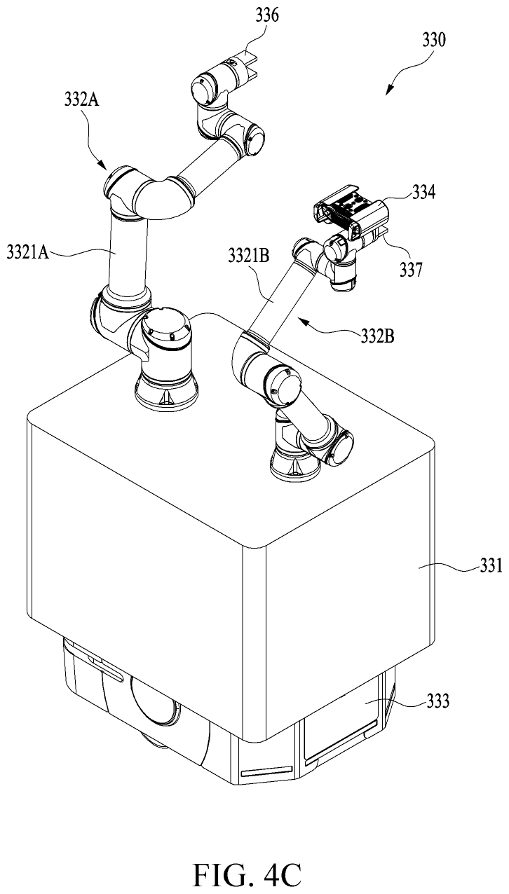

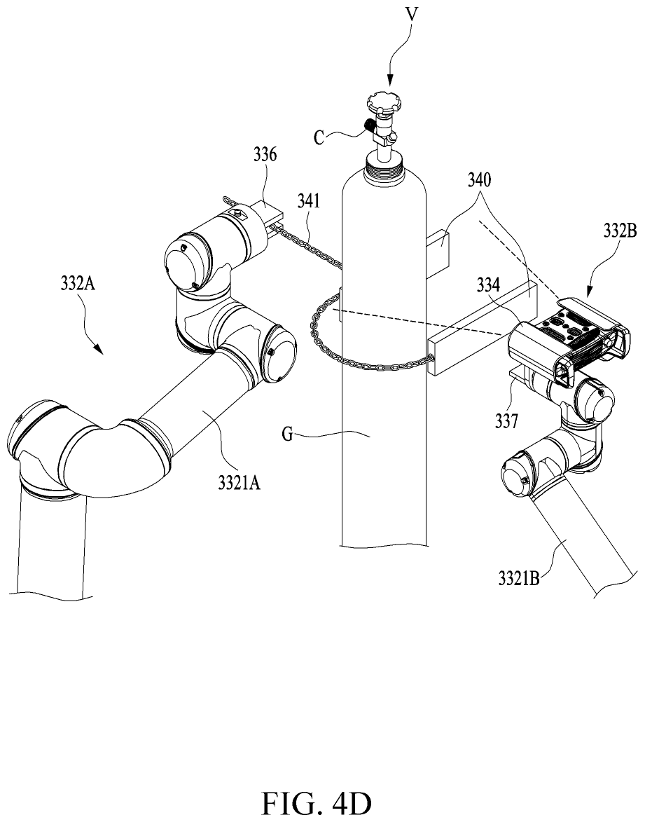

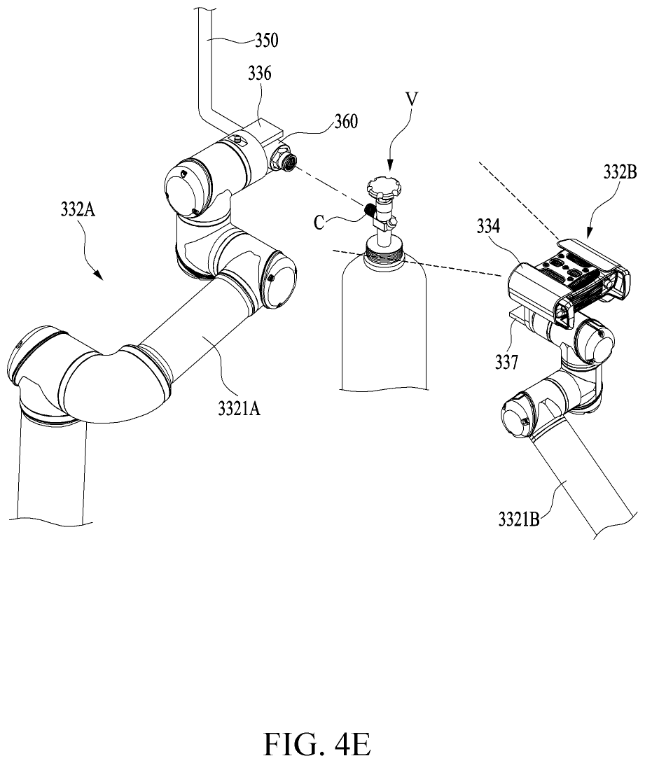

In an embodiment, the docking plate 1351 may be disposed at an end portion of the first collaborative robot 132A. In an embodiment, the docking plate 1351 may include a docking surface (e.g., the surface of the docking plate 1351 shown in FIG. 4B) that faces a surface (e.g., a surface facing the +Y axis of FIG. 3B) of the docking portion 113.

In an embodiment, the docking member 1353 may be disposed on the docking surface of the docking plate 1351. For example, the docking member 1353 may be formed to protrude from the docking surface. In an embodiment, the docking member 1353 may be optionally fastened to the docking clamp 1132 of the docking portion 113. For example, the docking member 1353 may be inserted and fastened to the docking clamp 1132. In an embodiment, when a plurality of docking clamps 1132 are disposed on the surface of the docking portion 113, a plurality of docking members 1353 may be formed on the docking surface of the docking plate 1351 at positions respectively corresponding to the plurality of docking clamps 1132.

In an embodiment, the power motor 136 may be installed at an end portion of the first collaborative robot 132A. The rotation shaft 1361 of the power motor 136 may penetrate through the docking plate 1351 and protrude from the docking surface of the docking plate 1351. In an embodiment, in a state in which the docking module 135 is fastened to the docking portion 113, for example, in a state in which the docking member 1353 is fastened to the docking clamp 1132, the rotation shaft 1361 of the power motor 136 may be inserted into the power transmitter 1131 formed in the docking portion 113. The power motor 136 may transmit power to the fastening device 110 through the power transmitter 1131. The power transmitted from the power motor 136 to the fastening device 110 may be transmitted to the end cap detacher 111 and the connector 112 of the fastening device 110.

In an embodiment, for the docking module 135 to be fastened to the docking portion 113 of the fastening device 110, the docking module 135 needs to be aligned in a docking position to be fastenable to the docking portion 113. In an embodiment, as shown in FIG. 2G, in the state in which the docking module 135 is aligned to be fastenable to the docking portion 113, the docking member 1353 of the docking module 135 and the rotation shaft 1361 of the power motor 136 may be disposed at positions corresponding to the docking clamp 1132 and the power transmitter 1131 of the docking portion 113, respectively. The docking position in which the docking module 135 is fastenable to the docking portion 113 of the fastening device 110 may relatively vary depending on the position and angle of the fastening device 110 in the cabinet 100.

In an embodiment, in a state in which the docking module 135 is fastened to the docking portion 113 of the fastening device 110, the docking module 135 and the fastening device 110 may move as an integral body, so that the position of the fastening device 110 in the internal space of the cabinet 100 may be adjusted by the first collaborative robot 132A. For example, the relative position of the fastening device 110 with respect to the valve C of the gas container G may be adjusted by the first collaborative robot 132A.

In an embodiment, the 3D vision camera 134 may collect images of the gas supply system 1. For example, the 3D vision camera 134 may collect 3D images of the gas supply system 1 including the docking module 135, the fastening device 110, and the valve C of the gas container G. In an embodiment, the 3D vision camera 134 may be disposed at an end portion of the first collaborative robot 132A, for example, on an upper portion of the docking plate 1351. The 3D vision camera 134 may be disposed on the first collaborative robot 132A to collect front view images of the docking module 135 facing the docking portion 113, for example, images in the direction of the docking surface of the docking plate 1351.

In an embodiment, the image collection position of the 3D vision camera 134 is not limited to the example described above, and may be set to collect images in various directions depending on the set conditions. For example, the 3D vision camera 134 may be disposed on the first collaborative robot 132A to collect down view images of the docking module 135, for example, images in the direction of the ground of the docking plate 1351.

In an embodiment, the controller may control the operation of the mobile robot device 130. In an embodiment, the controller may move the mobile robot device 130 toward the cabinet 100 or away from the cabinet 100.

In an embodiment, during the process of connecting the mobile robot device 130 to the fastening device 110, the controller may operate the first collaborative robot 132A so that the docking module 135 may be fastened to the docking portion 113 of the fastening device 110, based on the 3D images collected by the 3D vision camera 134.

In an embodiment, in a state in which the mobile robot device 130 is connected to the fastening device 110, the controller may align the fastening device 110 with respect to the valve C of the gas container G by operating the first collaborative robot 132A based on the images collected by the 3D vision camera 134. For example, the controller may adjust the position and angle of the fastening device 110 by moving and adjusting the docking module 135, so that the fastening device 110 may be aligned in a first state in which the fastening device 110 may detach/mount the end cap from/on the valve C or in a second state in which the fastening device 110 is fastenable to the valve C.

In an embodiment, the controller may determine one or more alignment positions of the docking module 135 according to a set algorithm, and control the operation of the first collaborative robot 132A so that the docking module 135 is placed in the determined alignment position. An alignment position of the docking module 135 may include 3D coordinates and a 3D rotation angle thereof in the cabinet 100.

In an embodiment, an alignment position of the docking module 135 may be determined according to the operational purpose according to the process sequence of the gas supply system 1. In an embodiment, in the process of fastening the mobile robot device 130 to the fastening device 110, the alignment position of the docking module 135 may be a first alignment position in which the docking module 135 is in the fastening state of being relatively aligned to be fastenable to the fastening device 110, that is, in which the docking module 135 is in the fastening state of being aligned to be fastenable in response to the position and angle of the docking portion 113.

In an embodiment, in a state in which the mobile robot device 130 is fastened to the fastening device 110, that is, in a state in which the docking module 135 is fastened to the docking portion 113, the alignment position of the docking module 135 may be a second alignment position of the docking module 135 in which the fastening device 110 is in the first state with respect to the valve C of the gas container G. For example, the second alignment position of the docking module 135 may indicate the position and angle of the docking module 135 in which the end cap detacher 111 of the fastening device 110 causes the first rotation axis A1 to coincide with the central axis of the valve C in response to the position and angle of the valve of the gas container G.

In an embodiment, in a state in which the mobile robot device 130 is fastened to the fastening device 110, that is, in a state in which the docking module 135 is fastened to the docking portion 113, the alignment position of the docking module 135 may be a third alignment position of the docking module 135 in which the fastening device 110 is in the second state with respect to the valve C of the gas container G. For example, the third alignment position of the docking module 135 may indicate the position and angle of the docking module 135 in which the second rotation axis A2 of the connector 112 of the fastening device 110 coincides with the central axis of the valve C in response to the position and angle of the valve of the gas container G.

In an embodiment, the controller may determine the alignment position of the docking module 135 according to a set algorithm. For example, the set algorithm may be set to generate a 3D model of a virtual space, for example, a 3D model of the docking module 135, the gas container G, and the fastening device 110, in real time through images acquired by the 3D vision camera 134. In an embodiment, the 3D model may change based on real-time images acquired by the 3D vision camera 134. In an embodiment, the set algorithm may determine an image similarity by comparing a generated 3D image with a set reference model. For example, the set reference model may be a 3D model in a docking position in which the docking module 135 is aligned to be fastenable to the docking portion 113. For example, the set reference model may be a 3D model in a state in which the fastening device 110 connected to the docking module 135 is aligned in the first position with respect to the valve C of the gas container G. For example, the set reference model may be a 3D model in a state in which the fastening device 110 connected to the docking module 135 is aligned in the second position with respect to the valve C of the gas container G. In an embodiment, the set algorithm may be set to determine the need for position adjustment of the docking module 135 by determining the image similarity between the generated 3D image and the set reference model.

In an embodiment, if the image similarity is greater than or equal to a set value, the set algorithm may be set to generate an instruction to perform an operation determined according to the reference model. For example, if the reference model is a 3D model in a docking position in which the docking module 135 is aligned to be fastenable to the docking portion 113, the set algorithm may be set to generate an instruction to perform an operation of fastening the docking module 135 to the docking portion 113 when the image similarity is greater than or equal to the set value. For example, if the reference model is a 3D model in a state in which the fastening device 110 is aligned in the first position with respect to the valve C, the set algorithm may be set to generate an instruction to operate the end cap detacher 111 to remove the end cap from the valve C when the image similarity is greater than or equal to the set value. For example, if the set reference model is a 3D model in a state in which the fastening device 110 is aligned in the second position with respect to the valve C of the gas container G, the set algorithm may be set to generate an instruction to operate the connector 112 to be fastened to the valve C when the image similarity is greater than or equal to the set value.

In an embodiment, if the image similarity is greater than or equal to the set value, the set algorithm may be set to predict a position of the docking module 135 in which the 3D model has an image similarity to the reference model greater than or equal to the set value and determine the predicted position to be the alignment position of the docking module 135.

In an embodiment, when the set algorithm determines the alignment position of the docking module 135, the controller may adjust the 3D coordinates and the 3D rotation angle of the docking module 135 by controlling the first collaborative robot 132A so that the docking module 135 may be positioned at the determined alignment position.

In an embodiment, the controller may align the fastening device 110 connected to the docking module 135 by moving the docking module 135 through the operation of the first collaborative robot 132A, in a state in which the docking module 135 is fastened to the docking portion 113. In an embodiment, the controller may control the operation of the first collaborative robot 132A so that the fastening device 110 is in the first position with respect to the valve C of the gas container G, based on the images collected by the 3D vision camera 134. In an embodiment, the controller may control the power motor 136 to transmit power to the power transmitter 1131 when the fastening device 110 is aligned in the first position with respect to the valve C of the gas container G, thereby operating the end cap detacher 111. In an embodiment, the controller may control the operation of the first collaborative robot 132A so that the fastening device 110 is in the second position with respect to the valve C of the gas container G, based on the images collected by the 3D vision camera 134. In an embodiment, the controller may control the power motor 136 to transmit power to the power transmitter 1131 when the fastening device 110 is aligned in the second position with respect to the valve C of the gas container G, thereby operating the connector 112.

In an embodiment, the gas supply system 1 may transmit power from the outside of the fastening device 110 through the mobile robot device 130 and align the fastening device 110, thereby eliminating a separate component (e.g., an actuator, etc.) for operating the fastening device 110. Accordingly, the structure of the fastening device 110 may be simplified, improving the maintenance convenience. In addition, the gas supply system 1 may reduce the space occupied by the fastening device 110 in the cabinet 100, thereby reducing spatial constraints for installation of the gas supply system 1.

FIG. 3A is a perspective view of a gas supply system according to an embodiment. FIG. 3B is a perspective view of a mobile robot device according to an embodiment. FIG. 3C is a view illustrating a docking module according to an embodiment. FIG. 3D is an operational view illustrating a process of aligning a first collaborative robot and a second collaborative robot using a three-dimensional (3D) vision camera in a gas supply system according to an embodiment. FIG. 3E is a view illustrating a process of fastening a mobile robot device to a fastening device according to an embodiment.

In describing FIGS. 3A to 3E, unless otherwise stated, terms identical to those described above may be understood as referring to the same or similar elements.

Referring to FIGS. 3A to 3E, a gas supply system 2 according to an embodiment may include a cabinet 200 in which a gas container G is disposed, a fastening device 210 on which a connector 212 is mounted, and a mobile robot device 230 configured to fasten the connector 212 to a valve C of the gas container G by moving the fastening device 210.

In an embodiment, one or more gas containers G may be safely plated in the cabinet 200. A support to support the gas container G may be installed in the cabinet 200, and a support frame or support clamp to support the outer circumferential surface of the gas container G placed on the support may be installed.

In an embodiment, the fastening device 210 may detach and couple an end cap E from and to the valve C of the gas container G, or may be fastened to the valve C of the gas container G to receive a process gas from the gas container G. In an embodiment, a number of fastening devices 210 corresponding to the number of gas containers G disposable in the cabinet 200 may be provided. For example, if two gas containers G are safely placed in the cabinet 200 as shown in FIG. 3A, the gas supply system 2 may include two fastening devices 210. However, this is an example, and the number of fastening devices 210 may be changed depending on the design.

In an embodiment, the fastening device 210 may be movably installed in the cabinet 200. For example, the fastening device 210 may be connected to the cabinet 200 through a position adjustment module (not shown), and the position and rotation angle thereof in the cabinet 200 may be adjusted through the operation of the position adjustment module. For example, the fastening device 210 may be connected to the cabinet 200 to have a six-degree-of-freedom motion of x-, y-, z-axes and yaw, pitch, and roll in the cabinet 200. In an embodiment, the position adjustment module may movably support the fastening device 210 in the cabinet 200 according to a motion of the fastening device 210.

In an embodiment, the fastening device 210 may include an end cap detacher 211 for removing or detaching the end cap E from the valve C of the gas container G, a connector 212 fastened to the valve C of the gas container G to receive a process gas, and a docking portion 213 to be fastened to the mobile robot device 230 described later.

In an embodiment, the end cap detacher 211 may grip the end cap E mounted on the valve C of the gas container G. In an embodiment, the end cap detacher 211 may detach the end cap E from the valve C, grip the end cap E, and mount the end cap E again on the valve C after the gas container G is used. In an embodiment, the end cap detacher 211 may include an insertion recess into which the end cap E is inserted. In this case, the insertion recess may have a shape corresponding to the cross section of the end cap E. The end cap detacher 211 may rotate about a first rotation axis. In a state in which the end cap detacher 211 is aligned to be capable of detaching the end cap E from the valve C, the first rotation axis of the end cap detacher 211 may be placed in an axial alignment state to coincide with the center of the valve C.

In an embodiment, the angle of the end cap detacher 211 may be adjusted to match the cross-sectional shape of the insertion recess with the cross-sectional shape of the end cap E in a state in which the first rotation axis is axially aligned to pass through the center of the valve C. In this case, the end cap detacher 211 may rotate about the first rotation axis so that the rotation angle thereof with respect to the end cap E mounted on the valve C may be adjusted.

In an embodiment, when the axial alignment and angle adjustment of the end cap detacher 211 with respect to the end cap E is completed, the end cap detacher 211 may advance toward the end cap E along the first rotation axis and accommodate the end cap E in the insertion recess. With the end cap E inserted into the insertion recess, the end cap detacher 211 may detach the insertion recess from the valve C of the gas container G while rotating about the first rotation axis. Since the end cap E is mounted on the outer circumferential surface of the valve C of the gas container G in a screwing manner, the end cap E may be detached from the valve C of the gas container G by rotating the end cap E through the rotation of the end cap detacher 211. The end cap E may be mounted again on the valve C by performing the operation of detaching the end cap E reversely.

In an embodiment, the connector 212 may be connected to a gas pipe and fastened to the valve C of the gas container G with the end cap E detached, to receive a gas from the gas container G and supply the gas to the gas pipe. In an embodiment, the connector 212 may rotate about a second rotation axis. The connector 212 may translate forward and backward along the second rotation axis with respect to the fastening device 210. In a state in which the second rotation axis of the connector 212 is aligned substantially to coincide with the center of the valve C of the gas container G, the connector 212 may be fastened to the valve C while advancing along the second rotation axis.

In an embodiment, the operation of the end cap detacher 211 and the connector 212 of the fastening device 210 may be performed by power received from the mobile robot device 230 described later.

Meanwhile, for ease of description, an embodiment in which the end cap detacher 211 and the connector 212 of the fastening device 210 rotate about the first rotation axis and the second rotation axis, which are different, is shown in the drawings, but the fastening device 210 may be formed in various structures. For example, the fastening device 210 may be formed in a structure in which the end cap detacher 211 and the connector 212 rotate about one rotation axis. For example, by forming the connector 212 in the insertion recess of the end cap detacher 211, the connector 212 and the end cap detacher 211 may be formed as a single structure. In this case, the fastening device 210 may be placed in a state of being fastenable to the valve C of the gas container G by matching the rotation axis of the connector 212 and the end cap detacher 211 with the center of the valve C of the gas container G.

In an embodiment, the docking portion 213 may be formed on one side of the fastening device 210. For example, the docking portion 213 may be formed on a side surface of the fastening device 210 facing a door of the cabinet 200 (e.g., a side surface of the fastening device 210 facing the +Y axis of FIG. 2). In an embodiment, the mobile robot device 230 may be detachably connected to the docking portion 213. For example, a docking module 235 mounted on the first collaborative robot 232A described later may be mounted on the docking portion 213. In an embodiment, in a state in which the mobile robot device 230 is connected to the docking portion 213, the position of the fastening device 210 in the internal space of the cabinet 200 may be changed by the mobile robot device 230. In an embodiment, the docking portion 213 may be connected to the mobile robot device 230 to supply power from the mobile robot device 230 to the fastening device 210. For example, in a state in which the mobile robot device 230 is connected to the docking portion 213, the fastening device 210 may receive power supplied by the mobile robot device 230 through the docking portion 213 and operate the end cap detacher 211 and the connector 212. In an embodiment, the docking portion 213 may include one or more docking clamps 2132 to which the docking module 235 described later is fixedly coupled, and a power transmitter 2131 to which a power motor 236 of the docking module 235 is connected.

In an embodiment, the mobile robot device 230 may be detachably connected to the fastening device 210. The mobile robot device 230 may move and operate the fastening device 210 while connected to the fastening device 210. In an embodiment, the mobile robot device 230 may be disposed outside the cabinet 200. In an embodiment, the mobile robot device 230 may include a body 231, a traveling portion 233, a first collaborative robot 232A, a second collaborative robot 232B, a 3D vision camera 234, and a controller (not shown).

In an embodiment, the body 231 may form the exterior of the mobile robot device 230. Various parts for the operation of the mobile robot device 230 may be disposed inside the body 231.

In an embodiment, the traveling portion 233 may be disposed at the lower end of the body 231. The traveling portion 233 may move the body 231 along the ground. The traveling portion 233 may be provided in the form of a guide member that moves along a guide rail installed on the ground, or in the form of a wheel that moves on the ground. In an embodiment, the traveling portion 233 may operate to move the mobile robot device 230 according to an instruction from the controller.

In an embodiment, the first collaborative robot 232A and the second collaborative robot 232B may be disposed on the body 231 and operate independently. In an embodiment, the first collaborative robot 232A may be fastened to the fastening device 210 to operate the fastening device 210. In an embodiment, the second collaborative robot 232B may assist with an operation of fastening the fastening device 210 to the gas container G by gripping the gas container G, during the process in which the first collaborative robot 232A connects the fastening device 210 to the valve V of the gas container G. In an embodiment, the second collaborative robot 232B may mount a gasket on the valve C of the gas container G or detach a discarded gasket after use.

In an embodiment, the first collaborative robot 232A may include a first multi-joint arm 2321A having a multi-degree-of-freedom motion and a docking module 235 mounted on an end portion of the first multi-joint arm 2321A.

The docking module 235 may be aligned with respect to the fastening device 210 according to the operation of the first multi-joint arm 2321A, and connected to the docking portion 213 of the fastening device 210 while aligned. Herein, the position in which the docking module 235 is aligned to be fastenable to the fastening device 210 may be referred to as the “docking position”. In an embodiment, the docking module 235 may be connected to the docking portion 213 to provide power to operate the fastening device 210. In an embodiment, the docking module 235 may include a docking plate 2351, a docking member 2353, and a power motor 236.

In an embodiment, the docking plate 2351 may be disposed at an end portion of the first collaborative robot 232A. The docking plate 2351 may contact a surface of the docking portion 213 of the fastening device 210 through a docking surface.

In an embodiment, the docking member 2353 may be disposed on the docking plate 2351. The docking member 2353 may be fastened to the docking clamp 2132 of the docking portion 213 to couple the docking module 235 to the fastening device 210. For example, the docking member 2353 may be formed to protrude from the surface of the docking plate 2351, and may be fastened to the docking clamp 2132 by being inserted thereinto. When a plurality of docking clamps 2132 are formed in the docking portion 213, the docking member 2353 may be disposed on the docking plate 2351 to have a shape and arrangement corresponding to the plurality of docking clamps 2132.

The power motor 236 may be installed at an end portion of the first multi-joint arm 2321A. The power motor 236 may be disposed so that a rotation shaft 2361 thereof may penetrate through the docking plate 2351 and protrude from the docking surface of the docking plate 2351. In a state in which the docking module 235 is fastened to the docking portion 213, the rotation shaft 2361 of the power motor 236 may be inserted into the power transmitter 2131 formed in the docking portion 213 to transmit power. The power transmitted from the power motor 236 may be used to operate the end cap detacher 211 and the connector 212 of the fastening device 210.

In an embodiment, for the docking module 235 to be fastened to the docking portion 213 of the fastening device 210, the docking module 235 needs to be placed in the docking position to be fastenable to the fastening device 210. In an embodiment, the mobile robot device 230 may determine the docking position through the controller, and control the first collaborative robot 232A to place the docking module 235 in the docking position.

In an embodiment, in a state in which the docking module 235 is fastened to the docking portion 213 of the fastening device 210, the relative position of the fastening device 210 with respect to the cabinet 200 may be adjusted according to the operation of the docking module 235, for example, a motion of the first multi-joint arm 2321A. For example, the relative position and angle of the fastening device 210 with respect to the valve C of the gas container G may be adjusted by the first collaborative robot 232A.

In an embodiment, the second collaborative robot 232B may include a second multi-joint arm 2321B having a multi-degree-of-freedom motion, and a grip module 237 (e.g., the second grip module 237). In an embodiment, the grip module 237 may operate to grip an object. For example, the grip module 237 may grip a valve assembly V of the gas container G or an object, such as a gasket, mounted on the outer surface of the valve C of the gas container G. In an embodiment, the second collaborative robot 232B may assist with the operation of the first collaborative robot 232A through the grip module 237. For example, during the process in which the first collaborative robot 232A fastens the fastening device 210 to the valve C of the gas container G, the second collaborative robot 232B may grip the gas container G, for example, a valve assembly V of the gas container G, through the grip module 237, thereby reducing or preventing misalignment of the valve C while the fastening device 210 is fastened to the valve C of the gas container G. The mobile robot device 230 may determine a gripping position in which the grip 237 is aligned to be capable of gripping the gas container G through the controller, and control the second collaborative robot 232B to place the grip module 237 in the gripping position.

In an embodiment, the 3D vision camera 234 may collect images. For example, the 3D vision camera 234 may collect, for example, 3D images including the docking module 235, the fastening device 210, the grip module 237, and the valve C of the gas container G. In an embodiment, the 3D vision camera 234 may be disposed on the upper portion of the body 231. One or more 3D vision cameras 234 may be provided. In an embodiment, the 3D vision camera 234 may be disposed on at least one of the first collaborative robot 232A or the second collaborative robot 232B.

In an embodiment, the controller may control the operation of the mobile robot device 230. In an embodiment, the controller may control the operation of the first collaborative robot 232A and the operation of the second collaborative robot 232B based on the images collected by the 3D vision camera 234.

Referring to FIG. 3D, the controller may operate the first collaborative robot 232A to dock the docking module 235 on the docking portion 213 of the fastening device 210 based on the images collected by the 3D vision camera 234. The controller may determine the docking position in which the docking module 235 is aligned to be fastenable to the fastening device 210 based on the images collected by the 3D vision camera 234, and change the position and angle of the docking module 235 by moving the first collaborative robot 232A, that is, the first multi-joint arm 2321A to align the docking module 235 in the docking position.

Referring to FIG. 3E, the controller may operate the second collaborative robot 232B so that the grip module 237 may grip the gas container G based on the images collected by the 3D vision camera 234. The controller may determine the gripping position in which the grip module 237 is aligned to be capable of gripping the gas container G based on the images collected by the 3D vision camera 234, and control the second collaborative robot 232B to place the grip module 237 in a second alignment state. The second alignment state may be a state in which the grip module 237 can grip the valve assembly V of the gas container G.

In an embodiment, the controller may determine each alignment state through a set algorithm. The set algorithm may be set to generate a 3D model of a virtual space, for example, a 3D model of the docking module 235, the gas container G, and the fastening device 210, in real time through images acquired by the 3D vision camera 234. In an embodiment, the 3D model may change based on real-time images acquired by the 3D vision camera 234. In an embodiment, the set algorithm may determine an image similarity by comparing a generated 3D image with a set reference model. For example, the set reference model may be a 3D model in which the docking module 235 is aligned to be fastenable to the docking portion 213.

For example, the set reference model may be a 3D model in a state in which the fastening device 210 is aligned to be fastenable to the valve C of the gas container G. For example, the set reference model may be a 3D model in a state in which the docking module 235 is aligned to be fastenable to the docking portion 213 of the fastening device 210. In an embodiment, the set algorithm may be set to determine the need for position adjustment of the docking module 235 by determining the image similarity between the generated 3D image and the set reference model.

In an embodiment, if the image similarity is greater than or equal to a set value, the set algorithm may be set to generate an instruction to perform an operation determined according to the reference model. For example, if the reference model is a 3D model in which the docking module 235 is aligned to be fastenable to the docking portion 213, the set algorithm may be set to generate an instruction to perform an operation of fastening the docking module 235 to the docking portion 213 when the image similarity is greater than or equal to the set value. For example, if the reference model is a 3D model in which the end cap detacher 211 of the fastening device 210 is aligned with the valve C for their axes and angles to match, the set algorithm may be set to generate an instruction to operate the end cap detacher 211 to remove the end cap E from the valve C when the image similarity is greater than or equal to the set value. For example, if the set reference model is a 3D model in which the rotation axis of the connector 212 of the fastening device 210 is aligned to coincide with the valve C, the set algorithm may be set to generate an instruction to operate the connector 212 to be fastened to the valve C when the image similarity is greater than or equal to the set value.

In an embodiment, if the image similarity is greater than or equal to the set value, the set algorithm may be set to predict a position of the docking module 235 in which the 3D model has an image similarity to the reference model greater than or equal to the set value and determine the predicted position to be the docking position of the docking module 235.

In an embodiment, when the set algorithm determines the docking position of the docking module 235, the controller may adjust the 3D coordinates and the 3D rotation angle of the docking module 235 by controlling the first collaborative robot 232A so that the position and angle of the docking module 235 may be adjusted to the docking position. Thereafter, the controller may connect the first collaborative robot 232A to the fastening device 210 by fastening the docking module 235 to the docking portion 213.

In an embodiment, the controller may align the fastening device 210 through the operation of the first collaborative robot 232A in a state in which the docking module 235 is fastened to the docking portion 213. In an embodiment, the controller may control the operation of the first collaborative robot 232A so that the fastening device 210 is in a state of being fastenable to the valve C of the gas container G, based on the images collected by the 3D vision camera 234. In an embodiment, the controller may control the first multi-joint arm 2321A to axially and angularly align the end cap detacher 211 of the fastening device 210 with the valve C of the gas container G, and control the power motor 236 to transmit power to the fastening device 210 to operate the end cap detacher 211 when the end cap detacher 211 is aligned with respect to the valve C of the gas container G. In an embodiment, the controller may control the first multi-joint arm 2321A to align the connector 212 of the fastening device 210 with the valve C of the gas container G, and control the power motor 236 to transmit power to the fastening device 210 to operate the connector 212 when the connector 212 is aligned to be fastenable to the valve C of the gas container G.

In an embodiment, the controller may control the operation of the second collaborative robot 232B to assist with the operation of the first collaborative robot 232A, during the process in which the first collaborative robot 232A fastens the fastening device 210 to the valve C of the gas container G. For example, the controller may control the operation of the second collaborative robot 232B so that the grip module 237 is in the second alignment state to grip the gas container G, for example, the connector 212, based on the images collected by the 3D vision camera 234. The controller may control the operation of the second collaborative robot 232B so that the grip module 237 grips the valve assembly V to prevent misalignment of the valve C, during the process in which the first collaborative robot 232A fastens the fastening device 210 to the valve C of the gas container G.

In an embodiment, the controller may control the operation of the second collaborative robot 232B to replace a gasket before the fastening device 210 is fastened to the valve C of the gas container G. For example, the controller may control the operation of the second collaborative robot 232B so that the grip module 237 may replace a gasket between the connector 212 and the valve C of the gas container G based on the images collected by the 3D vision camera 234. When the gasket is removed by the grip module 237, the controller may control the second collaborative robot 232B so that the second collaborative robot 232B assists with the operation of fastening the fastening device 210 to the gas container G.

FIG. 4A is a perspective view of a gas supply system according to an embodiment. FIG. 4B is a view illustrating a state in which gas containers are disposed in a cabinet in a gas supply system according to an embodiment. FIG. 4C is a perspective view of a mobile robot device according to an embodiment. FIG. 4D is an operational view illustrating an operation of fastening a support chain by a mobile robot device according to an embodiment. FIG. 4E is an operational view illustrating a process of aligning a connector with a valve of a gas container using a 3D vision camera by a mobile robot device according to an embodiment.

Referring to FIGS. 4A to 4E, a gas supply system 3 according to an embodiment may automatically perform a series of operations to receive a process gas stored in a gas container G. For example, the gas supply system 3 may automatically detach an end cap E mounted on a valve C of the gas container G, and connect the gas container G and a gas pipe by fastening a connector 360 to the valve C of the gas container G from which the end cap E is detached.

In an embodiment, the gas supply system 3 may include a cabinet 300 in which the gas container G is disposed, the connector 360 fastened to the valve C of the gas container G to receive a gas, and a mobile robot device 330 configured to automatically fasten the connector 360 to the valve C of the gas container G.

In an embodiment, the cabinet 300 may form an internal space where a gas supply is performed. One or more gas containers G may be safely placed in the cabinet 300. The internal space of the cabinet 300 may be sealed while a process gas is supplied from the gas container G. The cabinet 300 may include a door (not shown) that is optionally open and closed to bring the gas container G therein and withdraw the used gas container G to the outside. The door may close the internal space of the cabinet 300 while the process in which the gas is supplied from the gas container G, thereby reducing or preventing the process gas from leaking to the outside of the cabinet 300.

In an embodiment, a support 342 may be installed in the cabinet 300 to support the lower end of the gas container G that is safely placed. The support 342 may support the gas container G and at the same time, align the valve C of the gas container G by rotating about an axis perpendicular to the ground. For example, since the valve C of the gas container G faces a side surface of the gas container G, the valve C of the gas container G may be disposed in a direction to be easily fastened to the connector 360 through the rotational motion of the support 342.

In an embodiment, a support frame 340 may be installed in the cabinet 300 to prevent the gas container G from falling over or deviating from a set position in the cabinet 300 by supporting the outer circumferential surface of the gas container G that is safely placed. In an embodiment, the cabinet 300 may include a support chain 341 to surround the gas container G that is safely placed in the cabinet 300. The support chain 341 may be optionally fastened to the cabinet 300 to optionally surround the gas container G. For example, both ends of the support chain 341 may be connected to the support frame 340 to surround the outer circumferential surface of the gas container G. Both ends of the support chain 341 may be optionally fastened to the support frame 340. For example, the support chain 341 may be unfastened from the support frame 340 to allow the gas container G to be brought in or withdrawn from the inside of the support frame 340, and may be fastened to the support frame 340 to surround the outer surface of the gas container G when the gas container G is safely placed on the inside of the support frame 340, thereby preventing the gas container G from falling over. The form of the support chain 341 shown in the drawing is an example, and the support chain 341 may be connected to the support frame 340 in various forms such as a belt or buckle.

In an embodiment, the support chain 341 may be optionally fastened to the support frame 340 by the mobile robot device 330 described below. This will be further described later.

Meanwhile, although not shown in the drawing, a support clamp may also be installed to enclose and support the outer circumferential surface of the gas container G, instead of the support frame 340.

In an embodiment, a supply pipe 350 connected to the outside of the cabinet 300 may be installed in the internal space of the cabinet 300. The supply pipe 350 may be connected to the valve C of the gas container G through the connector 360 to receive a process gas from the gas container G. The process gas brought in the supply pipe 350 may flow through an extension pipe extending to the outside of the cabinet 300 to be supplied to a position in which the process is performed. In an embodiment, the extension pipe may be formed of a flexible material, thereby changing shape. Accordingly, when connecting the connector 360 mounted on the end portion to the valve C of the gas container G, the shape change of the extension pipe may secure the positional degree of freedom of the connector 360 in the cabinet 300.

In an embodiment, the connector 360 may be mounted at the end portion of the supply pipe 350 positioned in the cabinet 300. The connector 360 may be fastened to the valve C while being aligned with the valve C of the gas container G. When the valve C is open after the connector 360 is fastened to the valve C, the process gas in the gas container G may be supplied to the supply pipe 350 through the connector 360.

In an embodiment, the connector 360 may include a pipe grid communicating with the supply pipe 350, and a connector housing in a shape surrounding the pipe grid. For example, the connector housing may be formed in a nut shape with an open front, and may include threads on its inner circumferential surface. The threads on the inner circumferential surface of the connector housing may be formed to engage with the threads formed on the outer circumferential surface of the valve C. In this case, the connector 360 may be coupled to the outer circumferential surface of the valve C in a manner of rotating about the central axis in a state in which the valve C is inserted into the connector housing. A gasket may be replaceably mounted on the inside of the connector housing. The gasket may perform the function of reducing or preventing the leakage of the process gas through the gap between the valve C and the connector housing when the valve C and the connector 360 are fastened.

In an embodiment, one or more supply pipes 350 and one or more connectors 360 connected to respective end portions of the supply pipes 350 may be disposed in the cabinet 300. A number of connectors 360 and supply pipes 350 corresponding to the number of gas containers G to be disposed in the cabinet 300 may be provided in the cabinet 300. For example, as shown in FIG. 2B, when the cabinet 300 is formed so that up to two gas containers G may be safely placed therein, two connectors 360 and two supply pipes 350 may be installed in the cabinet 300. However, this is an example for ease of description, and the number of connectors 360 may change depending on the design of the cabinet 300.

In an embodiment, the mobile robot device 330 may automatically fasten the connector 360 to the valve C of the gas container G. In an embodiment, the mobile robot device 330 may be disposed outside the cabinet 300. The mobile robot device 330 may be configured to fasten the connector 360 to the valve C from the outside of the cabinet 300, thereby minimizing the space occupied inside the cabinet 300. In an embodiment, the mobile robot device 330 may include a body 331, a traveling portion 333, a first collaborative robot 332A, a second collaborative robot 332B, a 3D vision camera 334, and a controller (not shown).

In an embodiment, the body 331 may form the exterior of the mobile robot device 330. Various parts (e.g., a battery, a processor, a communication device, etc.) for the operation of the mobile robot device 330 may be disposed inside the body 331. The body 331 may move outside the cabinet 300.

In an embodiment, the traveling portion 333 may be disposed at the lower end of the body 331. The traveling portion 333 may move the body 331 along the ground. For example, the traveling portion 333 may be provided in the form of a guide member that moves as guided along a guide rail installed on the ground, or in the form of a wheel that moves on the ground. In an embodiment, the traveling portion 333 may operate to move the mobile robot device 330, for example, to move the body 331 with respect to the cabinet 300, according to an instruction from the controller.

In an embodiment, the first collaborative robot 332A and the second collaborative robot 332B may be disposed on the body 331 and operate independently. In an embodiment, the first collaborative robot 332A and the second collaborative robot 332B may automatically fasten and detach the connector 360 to and from the valve C of the gas container G that is safely placed in the cabinet 300.

In an embodiment, the first collaborative robot 332A may detach and attach an end cap E mounted on the valve C of the gas container G, or directly fasten the connector 360 to the valve C of the gas container G. In an embodiment, the second collaborative robot 332B may assist with the operation of the first collaborative robot 332A by supporting the gas container G not to move by gripping the gas container G, during the process in which the first collaborative robot 332A attaches or detaches the connector 360 or the end cap E to or from the valve C of the gas container G. In an embodiment, the second collaborative robot 332B may mount a gasket on the connector 360 or the valve C and detach a discarded gasket after use.

In an embodiment, the first collaborative robot 332A or the second collaborative robot 332B may assist with the process of bringing and withdrawing the gas container G in and from the cabinet 300. For example, in a state in which the gas container G is brought in the cabinet 300, the first collaborative robot 332A or the second collaborative robot 332B may apply an external force to the outer surface of the gas container G to move the gas container G to be aligned in a safe placing position on the cabinet 300. In an embodiment, the first collaborative robot 332A and the second collaborative robot 332B may adjust the position of the support chain 341 in the cabinet 300 so that the support chain 341 may surround or release the gas container G safely placed in the cabinet 300. For example, the first collaborative robot 332A and the second collaborative robot 332B may detach the support chain 341 from the support frame 340 during the process of bringing the gas container G in the cabinet 300. When the gas container G is aligned in the safe placing position within the cabinet 300, the first collaborative robot 332A or the second collaborative robot 332B may fasten the support chain 341 to the support frame 340 so that the support chain 341 surrounds the gas container G.

In an embodiment, the first collaborative robot 332A may include a first multi-joint arm 3321A having a multi-degree-of-freedom motion. The first multi-joint arm 3321A may be placed on the upper portion of the body 331. The first multi-joint arm 3321A may implement movement in six degrees of freedom, for example, 3D translational movement with respect to the ground (e.g., movement in the X-, Y-, and Z-axes) and 3D rotational movement (e.g., roll, yaw, and pitch).

In an embodiment, the first collaborative robot 332A may include a first grip module 336 mounted on an end portion of the first multi-joint arm 3321A. The first grip module 336 may include a gripper that operates to grip an object. The first grip module 336 may rotate the object. For example, the first grip module 336 may grip the end cap E or the connector 360. In an embodiment, the first grip module 336 may change shape to optionally grip the end cap E or the connector 360. For example, the first grip module 336 may include a gripper with variable spacing between both sides thereof to selectively contact a target object (e.g., the connector 360 or the end cap E). However, this is an example for ease of description, and the manner that the first grip module 336 grips an object is not limited thereto. For example, the first grip module 336 may be formed in a structure having a plurality of fingers each supporting a different site of the outer surface of an object.

In an embodiment, for the first grip module 336 to grip the target object (e.g., the connector 360 or the end cap E), the first grip module 336 needs to be placed in a state of being aligned with respect to the connector 360 or the end cap E to be capable of gripping the connector 360 or the end cap E. The mobile robot device 330 may obtain information about the alignment state of the first grip module 336 through the controller, and control, based on the obtained information, the operation of the first multi-joint arm 3321A of the first collaborative robot 332A so that the first grip module 336 is positioned in a first alignment state with respect to the target object (e.g., the connector 360 or the end cap E). Thereafter, in a state in which the first grip module 336 is placed in the alignment state with respect to the target object (e.g., the connector 360 or the end cap E), the first grip module 336 may operate to grip the target object. In an embodiment, in a state in which the first grip module 336 grips the target object, the first collaborative robot 332A may operate to place the target object in a set position and at a set angle.

In an embodiment, the first collaborative robot 332A may detach the end cap E mounted on the valve C, or mount the end cap E on the valve C of the gas container G after use, through the first grip module 336. For example, in a state in which the first grip module 336 grips the outer surface of the end cap E mounted on the valve C, the first collaborative robot 332A may rotate the end cap E through the first grip module 336, thereby unscrewing the end cap E from the valve C and detaching the end cap E from the valve C. Meanwhile, the first collaborative robot 332A may mount the end cap E on the valve C through a reverse operation.

In an embodiment, the first collaborative robot 332A may fasten the connector 360 to the valve C with the end cap E removed through the first grip module 336. For example, when the first grip module 336 grips the outer surface of the connector 360, the first collaborative robot 332A may move the connector 360 to be aligned in a position and at an angle to be fastenable to the valve C. Herein, the position of the connector 360 in a state of being aligned in a position and at an angle to be fastenable to the valve C may be referred to as the “valve C fastening position”. The first collaborative robot 332A may place the connector 360 in the valve C fastening position by adjusting the position of the connector 360 in the cabinet 300 through the operation of the first multi-joint arm 3321A. The valve C fastening position may be relatively determined depending on the state in which the gas container G is safely placed in the cabinet 300, that is, the state in which the valve C is positioned in the cabinet 300. In an embodiment, the first collaborative robot 332A may fasten the connector 360 to the valve C by rotating the connector 360 with respect to the valve C, in a state in which the connector 360 is placed in the valve C fastening position. The first collaborative robot 332A may detach the connector 360 fastened to the valve C from the valve C through a reverse operation.

In an embodiment, the second collaborative robot 332B may include a second multi-joint arm 3321B having a multi-degree-of-freedom motion. The second multi-joint arm 3321B, like the first multi-joint arm 3321A, may implement movement in six degrees of freedom. The second multi-joint arm 3321B may be placed on the upper portion of the body 331.

In an embodiment, the second collaborative robot 332B may include a second grip module 337 mounted on an end portion of the second multi-joint arm 3321B and configured to grip an object. For example, a grip module may grip a valve assembly V of the gas container G or an object, such as a gasket, mounted on the outer surface of the valve C of the gas container G. The second grip module 337 may be formed with a structure similar to that of the first grip module 336, but is not limited thereto. The shapes of the first grip module 336 and the second grip module 337 shown in the drawings are an example, and the second grip module 337 may be formed in various structures and sizes to grip a gas container G or a gasket.

In an embodiment, the second collaborative robot 332B may assist with the operation of the first collaborative robot 332A through the second grip module 337. The second collaborative robot 332B may support the gas container G by gripping the gas container G, for example, the valve assembly V, through the second grip module 337, during the process in which the first collaborative robot 332A detaches/attaches the end cap E from/to the valve C or detaches/attaches the connector 360. When the second grip module 337 supports the gas container G, misalignment of the valve C due to the movement of the gas container G when the first collaborative robot 332A detaches/attaches the end cap E or the connector 360 from/to the valve C may be reduced or prevented. In an embodiment, for the second collaborative robot 332B to grip the gas container G through the second grip module 337, the second grip module 337 needs to be aligned in a position and at an angle to be capable of gripping the gas container G. Herein, the position in which the second grip module 337 is aligned to be capable of gripping the gas container G, for example, a position in which the second grip module 337 is aligned to be capable of gripping the valve assembly V, may be referred to as the “gripping position”. In an embodiment, the mobile robot device 330 may obtain information about the gripping position through the controller, and control the operation of the second collaborative robot, for example, the second multi-joint arm 3321B, so that the second grip module 337 is placed in the gripping position with respect to the gas container G.

In an embodiment, the first collaborative robot 332A and the second collaborative robot 332B may optionally fasten the support chain 341 to the support frame 340 installed in the cabinet 300. For example, the first collaborative robot 332A or the second collaborative robot 332B may grip the support chain 341 through the first grip module 336 or the second grip module 337, respectively, and move the support chain 341 to optionally fasten or detach the support chain 341 to or from the support frame 340. In an embodiment, when one of the first collaborative robot 332A and the second collaborative robot 332B (e.g., the first collaborative robot 332A) grips the support chain 341 and fastens or detaches the support chain 341 to or from the support frame 340, the other collaborative robot (e.g., the second collaborative robot 332B) may grip and support the gas container G so as not to move. Of course, the opposite is also possible.

In an embodiment, the 3D vision camera 334 may collect images. For example, the 3D vision camera 334 may collect 3D images including, for example, the first grip module 336, the end cap E, the connector 360, the second grip module 337, and the valve C of the gas container G.

In an embodiment, the 3D vision camera 334 may be disposed on the upper portion of the body 331. One or more 3D vision cameras 334 may be provided. In an embodiment, the 3D vision camera 334 may be disposed on at least one of the first collaborative robot 332A or the second collaborative robot 332B. For example, the 3D vision camera 334 may be disposed at an end portion of the second multi-joint arm 3321B as shown in FIG. 3A, but may alternatively be disposed at an end portion of the first multi-joint arm 3321A. Additionally, a plurality of 3D vision cameras 334 may be provided and disposed at end portions of the first multi-joint arm 3321A and the second multi-joint arm 3321B, respectively.

In an embodiment, when the 3D vision camera 334 is disposed at the end portion of the second multi-joint arm 3321B, the mobile robot device 330 may control the second collaborative robot 332B to collect 3D images of the first grip module 336, the end cap E, the connector 360, and the valve C of the gas container G. By this structure, the 3D vision camera 334 may collect images of each component of the gas supply system 3 at an independent position, regardless of the operation of the first collaborative robot 332A. Conversely, when the 3D vision camera 334 is disposed at the end portion of the first multi-joint arm 3321A, the 3D vision camera 334 may collect a front view image of the first grip module 336, thereby collecting an intuitive image for alignment of the first grip module 336. In an embodiment, when a plurality of 3D vision cameras 334 are provided and disposed at the end portions of the first collaborative robot 332A and the second collaborative robot 332B, respectively, the mobile robot device 330 may collect 3D images at various angles through the two 3D vision cameras 334, thereby generating a more accurately calibrated 3D model through the collected images. Hereinafter, for ease of description, an embodiment will be described based on an example in which the 3D vision camera 334 is disposed on the second collaborative robot 332B.

In an embodiment, the controller may control the operation of the mobile robot device 330. In an embodiment, the controller may control the operation of the first collaborative robot 332A and the operation of the second collaborative robot 332B based on the images collected by the 3D vision camera 334.

In an embodiment, the controller may operate the first collaborative robot 332A so that the first grip module 336 may grip the end cap E or the connector 360 based on the images collected by the 3D vision camera 334. The controller may determine an alignment state for the position and angle for the first grip module 336 to be capable of gripping the end cap E or the connector 360 based on the collected images, and operate the first collaborative robot 332A so that the first grip module 336 is placed in the determined alignment state. For example, the alignment state may be a state in which the first grip module 336 is placed in a position and at an angle to be capable of gripping the end cap E or the connector 360.

When the first grip module 336 is placed in the alignment state, the controller may operate the first collaborative robot 332A to grip the end cap E or the connector 360 through the first grip module 336.

In an embodiment, the controller may control the first collaborative robot 332A and the second collaborative robot 332B to perform a detaching and fastening operation with respect to the valve C, in a state in which the first grip module 336 grips the end cap E or the connector 360.

In an embodiment, the controller may operate the second collaborative robot 332B to assist with the operation of the first collaborative robot 332A, during the process in which the first collaborative robot 332A attaches/detaches the connector 360 or the end cap E to/from the valve C. For example, in a state in which the first grip module 336 grips the connector 360 as shown in FIG. 3B, the controller may place the second grip module 337 in the gripping position to be capable of gripping the gas container G and then, control the operation of the second collaborative robot 332B so that the second grip module 337 grips and supports the outer surface of the gas container G, to fix the position of the gas container G. The controller may determine information about the gripping position in which the second grip module 337 is capable to gripping the gas container G based on the collected images.

In an embodiment, the controller may operate the second collaborative robot 332B to enable the second grip module 337 to replace a gasket between the valve C and the connector 360. The controller may determine the position and operating state in which the second grip module 337 is capable of replacing the gasket mounted on the valve C or the connector 360 based on the images collected by the 3D vision camera 334, and control the operation of the second collaborative robot 332B so that the second grip module 337 grips the gasket and mounts/detaches the gasket on/from the valve C or the connector 360 according to the determined state.

In an embodiment, the controller may operate the first collaborative robot 332A and the second collaborative robot 332B to assist with an operation of safely placing the gas container G in the cabinet 300, based on the information collected by the 3D vision camera 334. For example, the controller may collect the position of the gas container G in the cabinet 300 through the 3D vision camera 334, and operate the first grip module 336 or the second grip module 337 to grip the gas container G or push the gas container G to be moved to the alignment position on the cabinet 300 based on the collected information. For example, the controller may collect the position of the gas container G and information about the support chain 341 through the 3D vision camera 334, and operate the first grip module 336 or the second grip module 337 to grip the support chain 341 and detach or fasten the support chain 341 from or to the support frame 340 based on the collected information. In an embodiment, the controller may determine the operation information of the first collaborative robot 332A and the second collaborative robot 332B through a set algorithm. For example, the operation information of the first collaborative robot 332A and the second collaborative robot 332B may be information about the position and operation of the first grip module 336 and the position and operation of the second grip module 337.

In an embodiment, the set algorithm may be set to generate a 3D model of a virtual space, for example, a 3D model of the first grip module 336, the gas container G, the end cap E, and the connector 360, in real time through images acquired by the 3D vision camera 334. In an embodiment, the 3D model may change based on real-time images acquired by the 3D vision camera 334. In an embodiment, the set algorithm may determine an image similarity by comparing a generated 3D image with a set reference model.

In an embodiment, the set reference model may be a 3D model in which the first grip module 336 is aligned to be capable of gripping the end cap E or the connector 360. For example, the set reference model may be a 3D model in a state in which the end cap E or the connector 360 is aligned to be fastenable to the valve C of the gas container G. In an embodiment, the set algorithm may be set to determine the need for position adjustment of the first grip module 336 by determining the image similarity between the generated 3D image and the set reference model.

In an embodiment, if the image similarity is greater than or equal to a set value, the set algorithm may be set to generate an instruction to perform an operation determined according to the reference model. For example, if the reference model is a 3D model in which the first grip module 336 is aligned to be capable of gripping the end cap E or the connector 360, the set algorithm may be set to generate an instruction to perform an operation of gripping the end cap E or the connector 360 through the first grip module 336 when the image similarity is greater than or equal to the set value. For example, if the set reference model is a 3D model in which the rotation axis of the connector 360 gripped by the first grip module 336 is aligned to coincide with the valve C, the set algorithm may be set to generate an instruction to operate the connector 360 to be fastened to or detached from the valve C when the image similarity is greater than or equal to the set value. For example, if the reference model is a 3D model in which the first grip module 336 is aligned with the gripped end cap E for their axes and angles to match, the set algorithm may be set to generate an instruction to operate to attach or detach the end cap E when the image similarity is greater than or equal to the set value.

In an embodiment, if the image similarity is greater than or equal to the set value, the set algorithm may be set to predict a position of the first grip module 336 in which the 3D model has an image similarity to the reference model greater than or equal to the set value and determine the predicted position to be the alignment position of the first grip module 336.

In an embodiment, when the set algorithm determines the alignment position of the first grip module 336, the controller may adjust the 3D coordinates and the 3D rotation angle of the first grip module 336 by controlling the first collaborative robot 332A so that the first grip module 336 may be placed in the determined alignment position. For example, when a first alignment state in which the first grip module 336 is capable of gripping the end cap E or the connector 360 is determined, the controller may control the first collaborative robot 332A to place the first grip module 336 in the first alignment state.

In an embodiment, the controller may align the end cap E and the connector 360 through the operation of the first collaborative robot 332A, in a state in which the first grip module 336 grips the end cap E and the connector 360. In an embodiment, the controller may control the operation of the first collaborative robot 332A so that the end cap E or the connector 360 is in a state to be fastenable or detachable to or from the valve C of the gas container G, based on the images collected by the 3D vision camera 334. In an embodiment, the controller may determine a predicted position in which the end cap E or the connector 360 is axially and angularly aligned with the valve C of the gas container G, and control the first multi-joint arm 3321A to place the end cap E or the connector 360 in the determined predicted position. In an embodiment, the controller may control the first multi-joint arm 3321A to rotate the first grip module 336 to fasten or detach the end cap E or the connector 360 to or from the valve C of the gas container G when the end cap E or the connector 360 is aligned with respect to the valve C of the gas container G.

In an embodiment, the controller may control the operation of the second collaborative robot 332B to assist with the operation of the first collaborative robot 332A, during the process in which the first collaborative robot 332A fastens the end cap E or the connector 360 to the valve C of the gas container G. For example, the controller may control the operation of the second collaborative robot 332B so that the grip module is in a second alignment state to be capable of gripping the gas container G, for example, the valve C, based on the images collected by the 3D vision camera 334. The controller may control the operation of the second collaborative robot 332B so that the grip module grips the valve assembly V to prevent misalignment of the valve C, during the process in which the first collaborative robot 332A fastens a fastening device to the valve C of the gas container G.

In an embodiment, the controller may control the operation of the second collaborative robot 332B to replace a gasket before the connector 360 is fastened to the valve C of the gas container G. For example, the controller may control the operation of the second collaborative robot 332B so that the second grip module 337 is in a third alignment state to be capable of replacing a gasket between the connector 360 and the valve C of the gas container G, based on the images collected by the 3D vision camera 334. The controller may control the second grip module 337 to grip and remove the gasket and mount a new gasket on the valve C of the gas container G. When the gasket is removed by the second grip module 337, the controller may control the second collaborative robot 332B so that the second collaborative robot 332B assists with the operation of fastening the connector 360 to the gas container G.

The example illustrated in FIG. 4B illustrates an exemplary operating method of installing the support chain 341 on the circumference of the gas container G by the mobile robot device 330. For example, the mobile robot device 330 may collect position information of the gas container G through the 3D vision camera 334, and determine whether the gas container G is aligned in a safe placing position in the cabinet 300 based on the collected information. If the gas container G is not properly placed in the safe placing position, the mobile robot device 330 may move the gas container G to the safe place position through the first collaborative robot 332A or the second collaborative robot 332B. In an embodiment, when the gas container G is placed in the safe placing position in the cabinet 300, the mobile robot device 330 may collect position information of the support chain 341 through the 3D vision camera 334. The mobile robot device 330 may operate the first collaborative robot 332A (or the second collaborative robot 332B) so that the first grip module 336 (or the second grip module 337) grips the support chain 341 and fastens the gripped support chain 341 to the support frame 334, based on the collected information.

The example illustrated in FIG. 4C illustrates an exemplary operating method of fastening the connector 360 to the valve C of the gas container G by the mobile robot device 330. For example, the mobile robot device 330 may collect position information of the connector 360 through the 3D vision camera 334, and operate the first collaborative robot 332A so that the first grip module 336 grips the connector 360 based on the collected information. Thereafter, the mobile robot device 330 may operate the first collaborative robot 332A so that the connector 360 gripped by the first grip module 336 is aligned in a fastening position to be fastenable to the valve C, based on the position information of the valve C and the connector 360 collected through the 3D vision camera 334. In a state in which the connector 360 is aligned in the fastening position, the first collaborative robot 332A may operate to fasten the connector 360 to the valve E. During the process in which the first collaborative robot 332A fastens the connector 360 to the valve E, the second collaborative robot 332B may operate so that the second grip module 337 supports the gas container G by gripping the gas container G, for example, the valve assembly V. In an embodiment, the gas supply system 3 may transmit power from the outside through the mobile robot device 330 and align the connector 360, thereby eliminating a separate component (e.g., an actuator, etc.) for operating the connector 360. Accordingly, the structure of the cabinet 300 may be simplified, improving the maintenance convenience. In addition, the gas supply system 3 may reduce the space occupied by an automated device in the cabinet 300, thereby reducing spatial constraints for installation of the gas supply system 3.

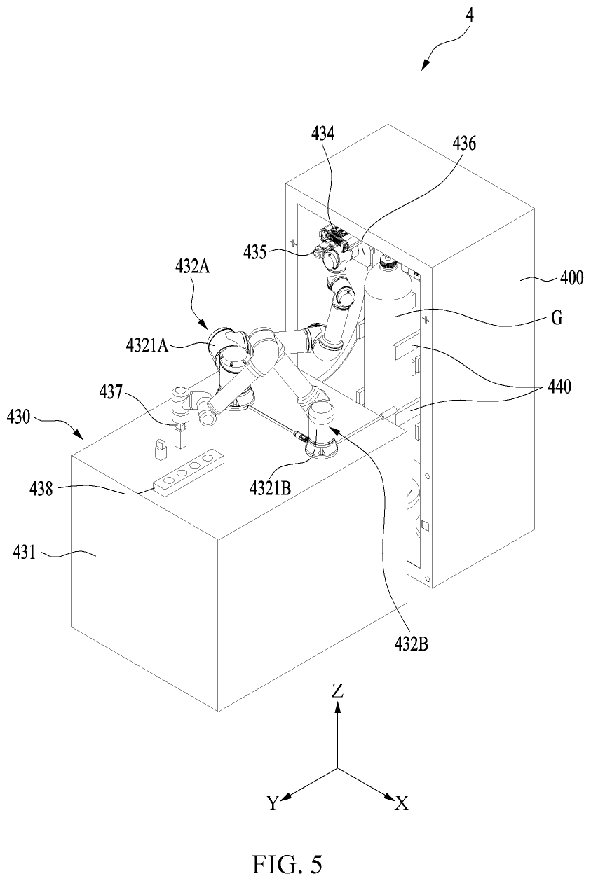

FIG. 5 is a perspective view of a mobile robot device according to an embodiment.

Referring to FIG. 5, a gas supply system 4 according to an embodiment may include a cabinet 400, a position adjustment module, a fastening device (e.g., the fastening device 110 of FIG. 2A), and a mobile robot device 430.

In an embodiment, the cabinet 400 may form an internal space where a gas container is disposed. In an embodiment, a support clamp 440 may be disposed in the cabinet 400 to support the outer circumferential surface of the gas container that is safely placed. In an embodiment, a support (not shown) supporting the gas container may be disposed on the floor surface of the internal space of the cabinet 400. In an embodiment, the position adjustment module (e.g., the position adjustment module 120 of FIG. 2) may movably connect the fastening device to the cabinet 400.

In an embodiment, the fastening device may be movably installed in the internal space of the cabinet 400, and may be fastened to a valve of the gas container in a state of being aligned with a valve of the gas container to receive a gas. In an embodiment, the fastening device may include an end cap detacher (e.g., the end cap detacher 111 of FIG. 3B) to remove an end cap mounted on the valve in a state of being aligned with respect to the valve at a first position, and a valve connector (e.g., the valve connector 112 of FIG. 3B) mounted on the valve in a state of being aligned with respect to the valve at a second position to receive a gas. In an embodiment, the fastening device may include a docking portion (e.g., the docking portion 113 of FIG. 3B) connected to the externally positioned mobile robot device 430 and configured to receive power from the mobile robot device 430.

In an embodiment, the mobile robot device 430 may move outside the cabinet 400. The mobile robot device 430 may be connected to the fastening device to move the fastening device, or supply power to the fastening device to operate the fastening device. In an embodiment, the mobile robot device 430 may include a body 431, a first collaborative robot 432A, a second collaborative robot 432B, a docking module 435, a 3D vision camera 434, a gasket gripper 437, a gasket storage 438, and a controller.

In an embodiment, the body 431 may form the body of the mobile robot device 430. In an embodiment, the body 431 may move along the ground.

In an embodiment, the first collaborative robot 432A may be disposed on the upper portion of the body 431. In an embodiment, the first collaborative robot 432A may include a first multi-joint arm 4321A that implements movement in multiple degrees of freedom, for example, movement in six degrees of freedom.

In an embodiment, the first collaborative robot 432A may include a docking module 435 disposed at an end portion of the first multi-joint arm 4321A. In an embodiment, the docking module 435 may be connected to a docking portion of the fastening device through the operation of the first multi-joint arm 4321A.

In an embodiment, the second collaborative robot 432B may be positioned on the upper portion of the body 431. In an embodiment, the first collaborative robot 432A may include a second multi-joint arm 4321B that implements movement in multiple degrees of freedom, for example, movement in six degrees of freedom.

In an embodiment, the 3D vision camera 434 may be disposed on at least one of the first collaborative robot 432A or the second collaborative robot 432B to collect 3D images including the docking module 435, the fastening device, and the valve of the gas container.

In an embodiment, the gasket gripper 437 may be installed on the second collaborative robot 432B. For example, the gasket gripper 437 may be installed at an end portion of the second multi-joint arm 4321B. In an embodiment, the gasket gripper 437 may move and operate to replace a gasket mounted between the valve and the valve connector by means of the second collaborative robot 432B. For example, the gasket gripper 437 may move between a gasket replacement position set by the second multi-joint arm 4321B and the gasket storage 438. For example, the gasket gripper 437 may operate to grip a discarded gasket in the gasket replacement position or to grip a new gasket and move to the gasket replacement position.

In an embodiment, the controller may determine a gasket replacement position for replacing a gasket based on the images collected by the 3D vision camera 434, and control the operation of the second robot arm 432B to move the gasket gripper 437 to the determined gasket replacement position.

In an embodiment, the gasket storage 438 may be disposed on the upper portion of the body 431. In an embodiment, the gasket storage 438 may include a wasted gasket storage box to accommodate wasted gaskets removed from the valve through the gasket gripper 437, and a new gasket storage box to store new gaskets to be gripped by the gasket gripper 437.

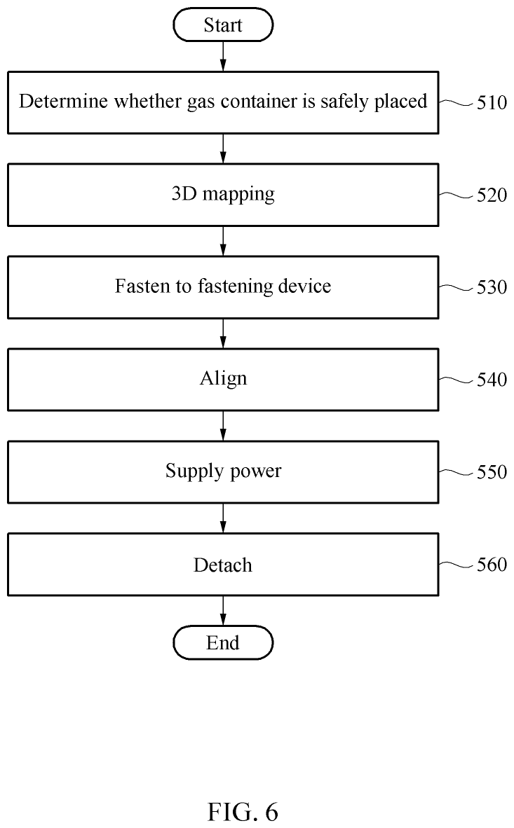

FIG. 6 is a flowchart of a gas supply method according to an embodiment.

At least one of the operations of the gas supply method shown in FIG. 6 may be omitted. The operations of the gas supply method may performed in a different order or at the same time, unless otherwise specified. At least one of the operations of the gas supply method may be performed repeatedly.

The gas supply method according to an embodiment may be performed by a gas supply system (e.g., the gas supply system 1 of FIG. 2A) including a fastening device and a mobile robot device including a docking module optionally connected to the fastening device to supply power to the fastening device. In an embodiment, the fastening device may include a valve connector fastened to a valve of a gas container to receive a gas, or an end cap detacher. In an embodiment, the mobile robotic device may include the docking module that is optionally connected to a docking portion of the fastening device to supply power to the fastening device. In an embodiment, the gas supply method may be performed by a controller.

In an embodiment, the gas supply method may include operation 510 of determining whether a gas container is safely placed. In operation 510, whether a gas container is safely placed at a gas supply position, for example, whether a gas container is safely placed in a safe placing space in a cabinet.

In an embodiment, the gas supply method may include operation 520 of generating a 3D model for the gas supply system. In operation 520, the docking module may be aligned by generating a 3D model of a virtual space according to relative positions of the gas container, the fastening device, and the docking module.

In an embodiment, operation 520 may include an operation of collecting a 3D image through a 3D vision camera, an operation of generating a 3D model for a virtual space based on the collected image, an operation of determining an image similarity by comparing the generated 3D model with a set reference model, and an operation of determining a predicted position of the docking module in which the image similarity is greater than or equal to a set value if the image similarity is less than the set value.

In an embodiment, the operation of generating a 3D model may vary depending on a real-time 3D image acquired by the vision camera.

In an embodiment, the operation of determining an image similarity may determine the image similarity by comparing a generated 3D image with the set reference model. For example, the set reference model may be a 3D model in a state in which the fastening device is aligned in a first position with respect to the gas container valve. For example, the set reference model may be a 3D model in a state in which the fastening device is aligned in a second position with respect to the gas container valve. In an embodiment, the operation of determining an image similarity may include determining the need for position adjustment of the docking module by determining the image similarity between the generated 3D image and the set reference model.

In an embodiment, the operation of determining an image similarity may include determining a subsequent operation determined according to the reference model if the image similarity is greater than or equal to the set value. For example, if the reference model is a 3D model in which the docking module is aligned to be fastenable to the docking portion, the subsequent operation corresponding to the image similarity greater than or equal to the set value may be an operation of fastening the docking module to the docking portion. For example, if the reference model is a 3D model in a state in which the fastening device is aligned in the first position with respect to the valve, the subsequent operation corresponding to the image similarity greater than or equal to the set value may be an operation of removing an end cap from the valve by the end cap detacher. For example, if the reference model is a 3D model in a state in which the fastening device is aligned in the second position with respect to the gas container valve, the subsequent operation corresponding to the image similarity greater than or equal to the set value may be an operation of fastening the valve connector to the valve.

In an embodiment, the operation of determining a predicted position of the docking module in which the image similarity is greater than or equal to a set value if the image similarity is less than the set value may include an operation of predicting a position of the docking module in which the 3D model has an image similarity to the reference model greater than or equal to the set value, and an operation of determining the predicted position to be an alignment position of the docking module.

In an embodiment, the gas supply method may include operation 530 of docking the docking module to the fastening device. Operation 530 may be performed when it is determined that the image similarity between the reference model for a state in which the docking module is fastenable to the fastening device and the generated 3D model is greater than or equal to the set value.

In an embodiment, the gas supply method may include operation 540 of operating the mobile robot device so that the fastening device is aligned with the gas container valve after the docking module is docked on the fastening device.

In an embodiment, operation 540 may be performed by determining the alignment position of the docking module by determining the similarity between the reference model in the state in which the fastening device is aligned in the first position with respect to the valve and the generated 3D image. Operation 540 may include aligning the fastening device integrally connected to the docking module to be in the first position, by operating the mobile robot device to move the docking module to the determined alignment position of the docking module.

In an embodiment, operation 540 may be performed by determining the alignment position of the docking module by determining the similarity between the reference model in the state in which the fastening device is aligned in the second position with respect to the valve and the generated 3D image. Operation 540 may include aligning the fastening device integrally connected to the docking module to be in the second position, by operating the mobile robot device to move the docking module to the determined alignment position of the docking module.

In an embodiment, the gas supply method may include operation 550 of supplying power to the fastening device through the docking module. In an embodiment, operation 550 may be performed in a state in which the fastening device is aligned in the first position or the second position with respect to the valve.

In an embodiment, the gas supply method may include operation 560 of detaching the docking module from the fastening device.

A number of embodiments have been described above. Nevertheless, it should be understood that various modifications and variations may be made to these embodiments. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and/or equivalents of the claims are within the scope of the following claims.

What is claimed is:

1. A gas supply system comprising:
a cabinet in which a gas container is disposed;
a connector fastenable to a valve of the gas container, the connector configured to supply a process gas in the gas container to a supply pipe while fastened to the valve; and
a mobile robot device disposed outside the cabinet and configured to automatically fasten the connector to the valve,
wherein the mobile robot device comprises:
a body movable outside the cabinet;
a first collaborative robot comprising a first multi-joint arm disposed on the body and having a multi-degree-of-freedom motion, the first collaborative robot configured to operate to fasten the connector to the valve;
a second collaborative robot comprising a second multi-joint arm disposed on the body and having a multi-degree-of-freedom motion, the second collaborative robot configured to operate to support the gas container;
a three-dimensional (3D) vision camera configured to collect an image; and
a controller configured to control an operation of the first collaborative robot and an operation of the second collaborative robot based on the image collected by the 3D vision camera.

2. The gas supply system of claim 1, wherein
the first collaborative robot further comprises a first grip module installed at an end portion of the first multi-joint arm and configured to grip the connector, and
the first collaborative robot is configured to fasten the connector to the valve in a state in which the first grip module grips the connector.

3. The gas supply system of claim 1, wherein
the controller is configured to determine operation information of the first collaborative robot according to a set algorithm, and
the set algorithm is configured to generate in real time a 3D model for the valve and the connector through the collected image, determine an image similarity by comparing the generated 3D model with a set reference model, and operate the first collaborative robot to place the connector in a predicted position of the connector in which the image similarity is greater than or equal to a set value.

4. The gas supply system of claim 1, wherein the controller is configured to:
determine a valve fastening position in which the connector is aligned to be fastenable to the valve based on the image collected by the 3D vision camera, and
control the operation of the first collaborative robot so that the connector is placed in the valve fastening position.

5. The gas supply system of claim 1, wherein the second collaborative robot further comprises a second grip module installed at an end portion of the second multi-joint arm and configured to grip an object.

6. The gas supply system of claim 5, wherein the second collaborative robot is configured so that the second grip module grips and supports the gas container, during a process in which the first collaborative robot operates to fasten the connector to the valve.

7. The gas supply system of claim 6, wherein the controller is configured to:
determine a gripping position for the second grip module to grip the gas container, based on the image collected by the 3D vision camera, and
operate the second collaborative robot to move to the gripping position and then grip the gas container.

8. The gas supply system of claim 5, wherein
the second collaborative robot is configured to grip a gasket through the second grip module, and
the controller is configured to operate the second grip module to detach and attach the gasket from and to the connector or the valve based on the image collected by the 3D vision camera.

9. The gas supply system of claim 1, wherein
the cabinet comprises a support chain to surround the gas container, and
the first collaborative robot or the second collaborative robot is configured to adjust a position of the support chain in the cabinet.

10. The gas supply system of claim 1, wherein one or more 3D vision cameras are provided, and disposed in at least one of the first multi-joint arm or the second multi-joint arm.

11. A gas supply system comprising:
a cabinet in which a gas container is disposed;
a fastening device configured to fasten a connector to a valve of the gas container while aligned with the valve; and
a mobile robot device configured to automatically align the fastening device to the gas container,
wherein the mobile robot device comprises:
a body movable along a ground;
a first collaborative robot disposed on the body, and comprising a first multi-joint arm;
a second collaborative robot disposed on the body, and comprising a second multi-joint arm; and
a three-dimensional (3D) vision camera configured to collect an image; and
a controller configured to control an operation of the first collaborative robot and an operation of the second collaborative robot based on the image collected by the 3D vision camera, and
the first collaborative robot is detachably connected to the fastening device and configured to move the fastening device.

12. The gas supply system of claim 11, wherein
the first collaborative robot further comprises a docking module installed at an end portion of the first multi-joint arm and docked on the fastening device while aligned with the fastening device, and
the docking module is configured to supply power to the fastening device while docked on the fastening device.

13. The gas supply system of claim 12, wherein the controller is configured to:
determine a docking position in which the docking module is aligned to be fastenable to the fastening device based on the image collected by the 3D vision camera, and
control the operation of the first collaborative robot so that the docking module is placed in the docking position.

14. The gas supply system of claim 11, wherein the docking module comprises:
a docking plate on which one or more docking members are formed; and
a power motor configured to supply power to the fastening device while docked on the fastening device, and
the fastening device comprises:
one or more support clamps detachably coupled to the docking member; and
a power transmitter to which the power motor is connected, the power transmitter configured to receive power from the power motor.

15. The gas supply system of claim 13, wherein
the docking position is determined according to a set algorithm, and
the set algorithm is configured to generate in real time a 3D model for a virtual space through the 3D vision camera, determine an image similarity by comparing the generated 3D model with a set reference model, and determine a predicted position of the docking module in which the image similarity is greater than or equal to a set value to be the docking position.

16. The gas supply system of claim 11, wherein
the fastening device further comprises an end cap detacher configured to remove an end cap from the valve of the gas container,
wherein the end cap detacher is rotatable about a first rotation axis,
the end cap detacher comprises an insertion recess formed in a shape corresponding to the end cap so that the end cap is insertable along the first rotation axis, and
the first rotation axis coincides with a central axis of the valve in a state in which the fastening device is aligned in a first position.

17. The gas supply system of claim 11, wherein
the connector is configured to rotate about a second rotation axis or translate along the second rotation axis, and
the second rotation axis coincides with a central axis of the valve in a state in which the fastening device is aligned in a second position.

18. A gas supply system comprising:
a cabinet in which a gas container is disposed;
a fastening device movably installed in the cabinet and fastened to a valve of the gas container through a connector while aligned with the valve; and
a mobile robot device disposed outside the cabinet and configured to automatically align the fastening device with the gas container,
wherein the fastening device comprises a docking portion configured to receive power from an outside,
the mobile robot device comprises:
a body movable along a ground;
a first collaborative robot disposed on the body, and comprising a first multi-joint arm;
a second collaborative robot disposed on the body, and comprising a second multi-joint arm;
a three-dimensional (3D) vision camera configured to collect an image; and
a controller configured to control an operation of the first collaborative robot and an operation of the second collaborative robot based on the image collected by the 3D vision camera,
the first collaborative robot comprises a docking module installed at an end portion of the first multi-joint arm, connected to the fastening device while aligned with the fastening device, and configured to operate the fastening device, and
the second collaborative robot comprises a gasket gripper installed at an end portion of the second multi-joint arm and configured to grip a gasket.

19. The gas supply system of claim 18, wherein the mobile robot device further comprises a gasket storage disposed in the body and configured to store the gasket.

20. The gas supply system of claim 18, wherein the controller is configured to determine a gasket replacement position to replace the gasket based on the image collected by the 3D vision camera, and control the operation of the second collaborative robot to move the gasket gripper to the determined gasket replacement position.
